(19) United States
(12) Patent Application Publication
(10) Pub. No.: US 2025/0361914 A1
(43) Pub. Date: Nov. 27, 2025

(54) OIL ASSEMBLY FOR A DRIVELINE

(71) Applicant: POLARIS INDUSTRIES INC., Medina, MN (US)

(72) Inventors: Zacharey J. HUSSONG, Melbourne (AU); Jeffrey I. PETERMAN, Wyoming, MN (US); Gregory SPROUSE, Wyoming, MN (US)

(21) Appl. No.: 19/205,228

(22) Filed: May 12, 2025

Related U.S. Application Data
(60) Provisional application No. 63/651,219, filed on May 23, 2024.

(51) Int. Cl. F16D 13/74; F01M 1/06; F01M 11/02

(52) U.S. Cl. CPC F16D 13/74; F01M 1/06; F01M 11/02

(57) ABSTRACT

A driveline assembly includes an engine including a crankcase. A crankshaft is positioned within the crankcase and a transmission assembly is operably coupled to the crankshaft. A clutch assembly is operably coupled between the crankshaft and the transmission and the clutch assembly has a first side facing the transmission and a second side facing the engine. An oil assembly includes an oil conduit, and the oil conduit is configured to direct fluid toward the first side of the clutch assembly.

### CROSS-REFERENCE TO RELATED APPLICATIONS

The present application claims priority to U.S. Provisional Patent Application No. 63/651,219, filed May 23, 2024, entitled OIL ASSEMBLY FOR A DRIVELINE, which is herein incorporated by reference in its entirety.

### FIELD OF THE DISCLOSURE

The present disclosure relates to an oil assembly for an engine and a clutch assembly.

### BACKGROUND OF THE DISCLOSURE

Utility and recreational vehicles may include launch clutches to control engagement speeds between an engine and a transmission. Launch clutches operate at high speeds and require lubrication and cooling. Oil assemblies are often utilized to provide lubrication and cooling to an engine. A problem exists in providing oil from an engine oil assembly to a clutch that is separated from a crankcase. The present disclosure provides a method for providing oil from an engine oil assembly to a clutch assembly separate from the crankcase.

### SUMMARY OF THE DISCLOSURE

In an embodiment of the present disclosure, a driveline is provided. The driveline includes an engine including a crankcase and a crankshaft positioned within the crankcase. A transmission assembly is operably coupled to the crankshaft and a clutch assembly is operably coupled between the crankshaft and the transmission. The clutch assembly has a first side facing the transmission and a second side facing the engine, and an oil assembly includes an oil conduit and the oil conduit is configured to direct fluid toward the first side of the clutch assembly.

In embodiments, the crankshaft defines the oil conduit, and the oil conduit is positioned along a rotational axis of the crankshaft.

In embodiments, the clutch assembly comprises a first clutch member and a second clutch member, and the second clutch member defines the oil conduit.

In embodiments, the oil conduit is a first oil conduit and the oil assembly further comprises a second oil conduit. Further, the crankshaft defines the second oil conduit and the second oil conduit is configured to direct the fluid to the first oil conduit.

In embodiments, the driveline assembly further includes a one-way clutch coupled between the first clutch member and the second clutch member and the first oil conduit is configured to direct the fluid to the one-way clutch member.

In embodiments, the driveline assembly further includes a bearing member operably coupled to the second clutch member, and the bearing member is positioned longitudinally intermediate the one-way clutch and the transmission assembly.

In embodiments, the oil conduit comprises a first oil conduit portion and a second oil conduit portion fluidly coupled to the first oil conduit portion. Further, the first oil conduit portion extends generally parallel to the crankshaft and the second oil conduit portion extends radially outwardly from the first oil conduit portion.

In embodiments, the oil conduit extends outwardly from the crankcase.

In embodiments, the clutch assembly comprises a first clutch member and a second clutch member, and the oil conduit extends across a first plane extending vertically through the first clutch member.

In embodiments, the oil conduit is a first oil conduit, and the second clutch member defines a second oil conduit, and the first oil conduit is fluidly coupled to the second oil conduit.

In embodiments, the second oil conduit is configured to direct the fluid to the first clutch member.

In embodiments, the driveline assembly further includes a one-way clutch positioned intermediate the first clutch member and the second clutch member, and the fluid is configured to pass through the one-way clutch.

In embodiments, the clutch assembly comprises a first clutch member rotatably coupled to the crankshaft and a second clutch member rotatably coupled to the transmission. Further, the second clutch member defines a second clutch member internal conduit, and the oil conduit is configured to direct fluid toward the second clutch member internal conduit.

In yet another embodiment of the present disclosure, a driveline assembly is provided. The driveline assembly includes an engine including a crankcase and a crankshaft positioned within the crankcase. The crankshaft includes a first metered opening and a second metered opening. Further, a transmission assembly is operably coupled to the crankshaft and an oil assembly is fluidly coupled to the first metered opening and the second metered opening.

In embodiments, the first metered opening is positioned along a rotational axis of the crankshaft.

In embodiments, the second metered opening is radially offset from the first metered opening.

In embodiments, the second metered opening is angled relative to the first metered opening.

In embodiments, the first metered opening is fluidly coupled to the second metered opening.

In embodiments, the crankshaft comprises a first end portion and a second end portion opposite the first end portion. Further, the first end portion comprises a flange extending outwardly from the first end portion, and the flange is positioned intermediate the first metered opening and the second metered opening.

In embodiments, a clutch assembly is coupled between the crankshaft and the transmission and the clutch assembly includes a first clutch member and a second clutch member. Further, a bearing is coupled between the first clutch member and the second clutch member and a one-way clutch is coupled between the first clutch member and the second clutch member. Further, the first metered opening is configured to provide a fluid to at least two of the first clutch member, bearing, and one-way clutch, and the second metered opening is configured to provide the fluid to at least one of the first clutch member, bearing, and one-way clutch.

In embodiments, the bearing is a first bearing, and a second bearing is coupled to the clutch assembly. Further, the first metered opening is configured to provide the fluid to each of the first clutch member, first bearing, second bearing, and one-way clutch.

In embodiments, the second metered opening is configured to provide the fluid to only the first clutch member.

In embodiments, the second metered opening is angled relative to the first metered opening.

In embodiments, the second metered opening creates a larger volumetric flow than the first metered opening.

In embodiments, the first metered opening and the second metered opening are differently sized.

In embodiments, the first metered opening and the second metered opening are similarly sized.

In embodiments, the driveline assembly further includes a bearing surrounding the crankshaft, and the bearing defines a channel.

In embodiments, the first metered opening and the second metered opening are fluidly coupled to the channel.

In embodiments, the crankshaft defines a conduit, and the conduit is fluidly coupled to the channel.

In embodiments, the crankshaft defines a flanged end, and the bearing is coupled between the flanged end and the crankcase.

In embodiments, the crankcase defines a cavity, and the cavity surround at least a portion of the bearing.

In embodiments, the bearing defines an aperture fluidly coupling the channel and the cavity.

In embodiments, a driveline assembly is provided. The driveline assembly includes an engine including a crankcase and the crankcase includes an outlet. The crankshaft is positioned within the crankcase and the crankshaft defines an internal conduit. A transmission assembly is operably coupled to the crankshaft and a clutch assembly is operably coupled between the crankshaft and the transmission. Further, the clutch assembly has a clutch assembly first side facing the transmission and a clutch assembly second side facing the engine. Further, an oil assembly is fluidly coupled to the outlet and the internal conduit, and the outlet is configured to direct fluid to a first one of the clutch assembly first side and clutch assembly second side, and the internal conduit configured to direct fluid to a second one of the clutch assembly first side and the clutch assembly second side.

In embodiments, the driveline assembly further includes a bearing operably coupled to the clutch assembly and a one-way clutch operably coupled to the clutch assembly. Further, the one of the outlet and the internal conduit that is configured to direct fluid to the clutch assembly first side is also configured to direct fluid to each of the bearing and the one-way clutch.

In embodiments, the driveline assembly further includes a nozzle positioned within the outlet.

In embodiments, the clutch assembly comprises a first clutch member and a second clutch member, and the first clutch member is rotatably coupled to the crankshaft and the second clutch member is rotatably coupled to the transmission.

In embodiments, the first clutch member comprises a shoe assembly, and the oil assembly is configured to direct fluid to the shoe assembly.

In embodiments, the first clutch member comprises a hub extending generally parallel to the crankshaft.

In embodiments, the second clutch member extends within the hub.

In embodiments, the hub comprises an aperture extending generally perpendicular to a clutch assembly rotation axis.

In embodiments, the driveline assembly further includes a first bearing, a second bearing, and a one-way clutch, and the one-way clutch is positioned intermediate the first bearing and the second bearing.

In embodiments, the one of the outlet and the internal conduit configured to direct fluid to the clutch assembly first side is configured to direct fluid to each of the first bearing, second bearing, and one-way clutch.

In embodiments, the clutch assembly comprises a first clutch member rotatably coupled to the crankshaft and a second clutch member rotatably coupled to the transmission. Further, the second clutch member has a first side facing the transmission and a second side facing the engine, the second bearing is coupled to the second clutch member on the first side facing the transmission, and the second clutch member includes a second clutch member conduit extending between the first side facing the transmission and the second side facing the engine.

In embodiments, the second clutch member conduit is directed at the second bearing.

In embodiments, the first bearing has a radially extending aperture.

In embodiments, the second clutch member defines a second clutch member internal conduit, and the internal conduit of the crankcase is configured to direct the fluid to the second clutch member internal conduit.

### BRIEF DESCRIPTION OF THE DRAWINGS

FIG. 1 is a front perspective view of a powertrain of the present disclosure;

FIG. 2 is a rear perspective view of the powertrain of FIG. 1;

FIG. 3 is a rear view of the powertrain of FIG. 1;

FIG. 4 is a top view of the powertrain of FIG. 1;

FIG. 5 is a perspective view of a portion of the powertrain of FIG. 1 including a crankshaft, cover, and clutch assembly;

FIG. 6 is an exploded view of the portion of the powertrain of FIG. 5;

FIG. 7 is an exploded view of the portion of the powertrain of FIG. 5;

FIG. 8 is an exploded view of a clutch of the present disclosure;

FIG. 9 is an exploded view of the clutch of FIG. 8;

FIG. 10 is a rear view of the crankshaft of the powertrain of FIG. 1;

FIG. 11 is a diagrammatic view of an oil assembly of the powertrain of the present disclosure;

FIG. 12 is a cross-section view of the crankcase of the powertrain of FIG. 1, taken along line 12-12 of FIG. 4;

FIG. 13 is a cross-section view of the powertrain of FIG. 1, taken along line 13-13 of FIG. 3;

FIG. 14 is a cross-section view of the powertrain of FIG. 1, taken along line 14-14 of FIG. 3;

FIG. 15 is a cross-section view of an alternative powertrain of the present disclosure;

FIG. 16A is a cross-section view of an alternative powertrain of the present disclosure;

FIG. 16B is a cross-section view of the alternative powertrain of FIG. 16A of the present disclosure;

FIG. 17 is a cross-section view of an alternative powertrain of the present disclosure;

FIG. 18 is a cross-section view of an alternative powertrain of the present disclosure;

FIG. 19 is a cross-section view of an alternative powertrain of the present disclosure; and

FIG. 20 is a cross-section view of an alternative powertrain of the present disclosure.

### DETAILED DESCRIPTION

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

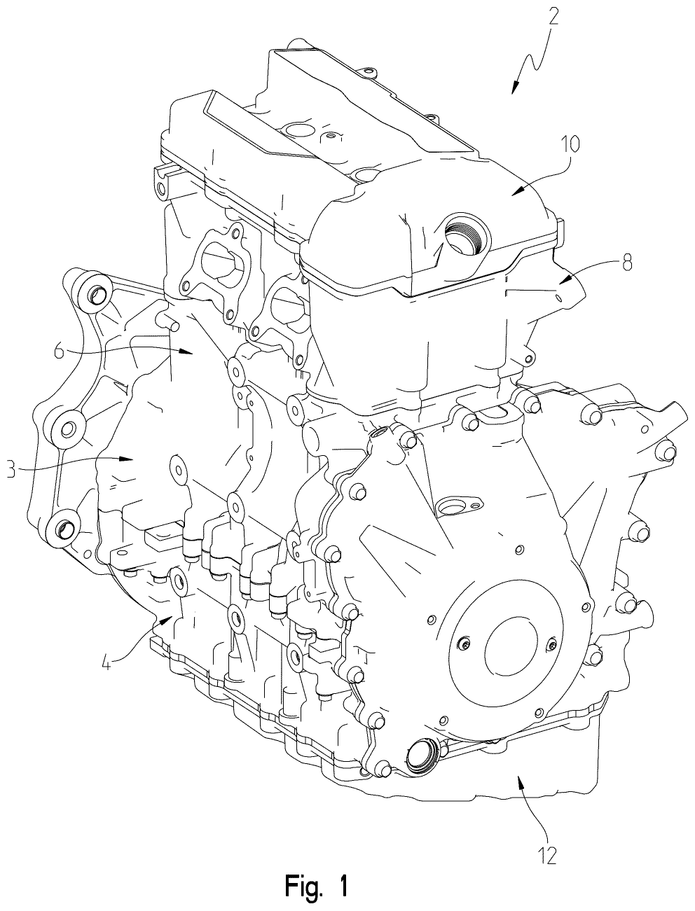

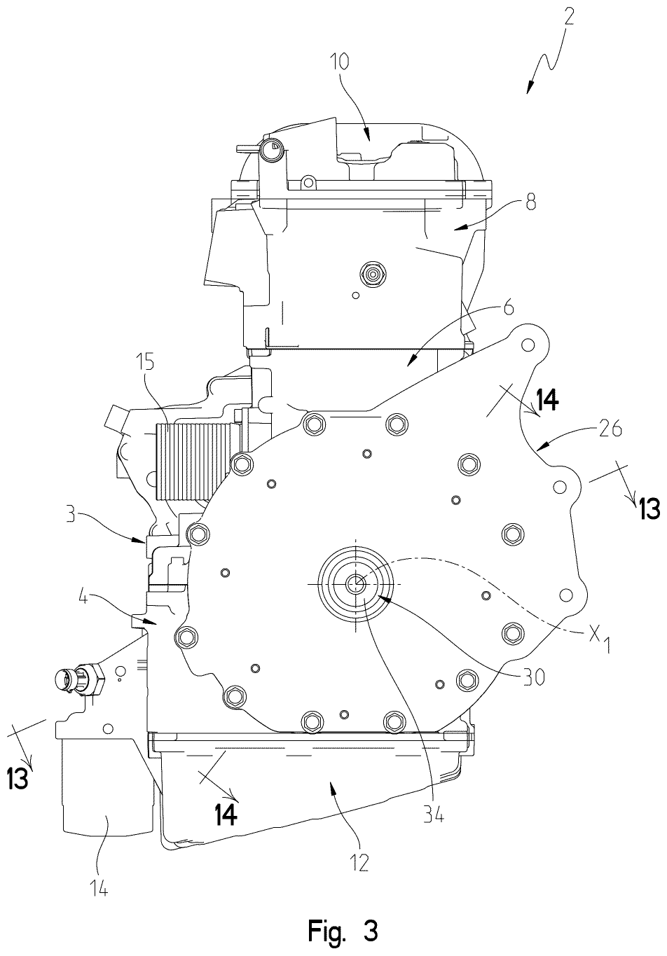

Referring now to FIGS. 1-4, an engine 2, or powertrain 2 is provided including a crankcase 3 comprising a first crankcase portion 4 and a second crankcase portion 6 coupled to the first crankcase portion 4. In embodiments, first crankcase portion 4 and second crankcase portion 6 are integral to each other creating a unitary crankcase 3. Engine 2 also comprises a cylinder head 8 coupled to the second crankcase portion 6 and a valve cover 10 coupled to the cylinder head 8. Further, an oil pan 12 is coupled to the first crankcase portion 4. In embodiments, one or more of first crankcase portion 4, second crankcase portion 6, cylinder head 8, valve cover 10, and oil pan 12 are integral with each other.

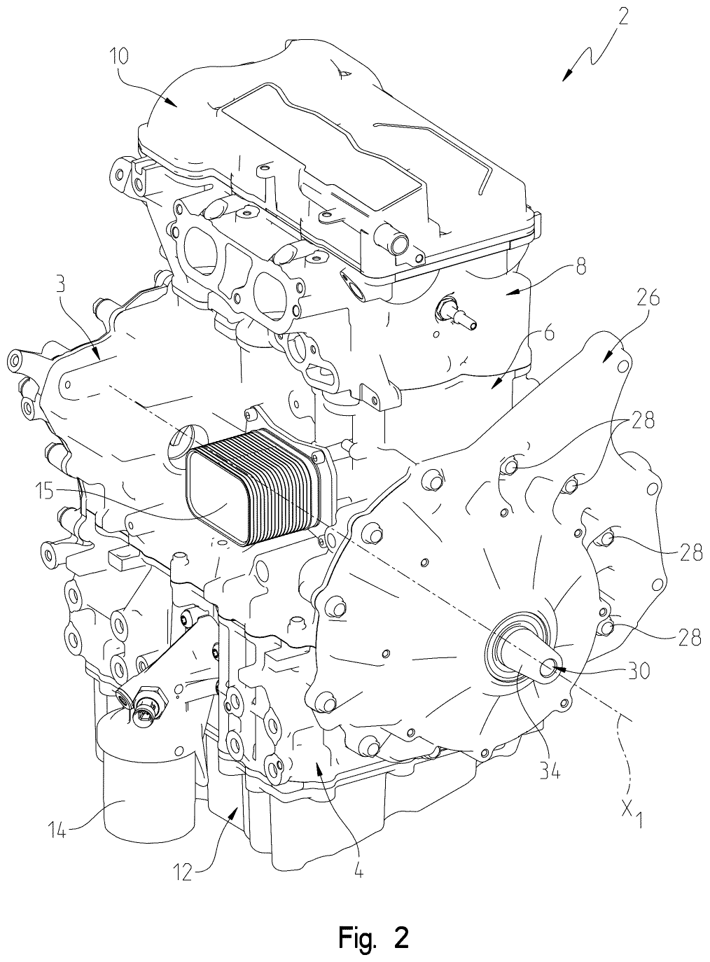

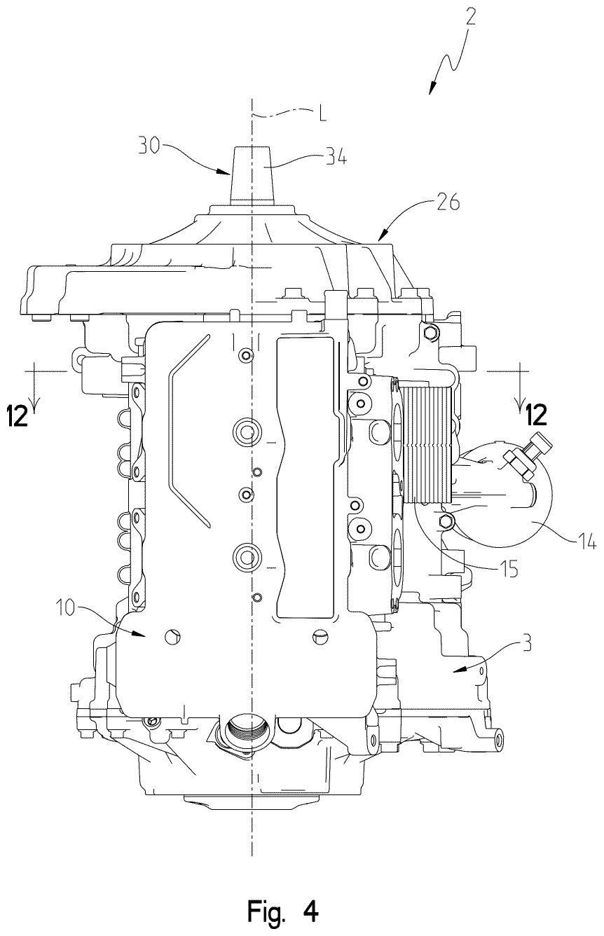

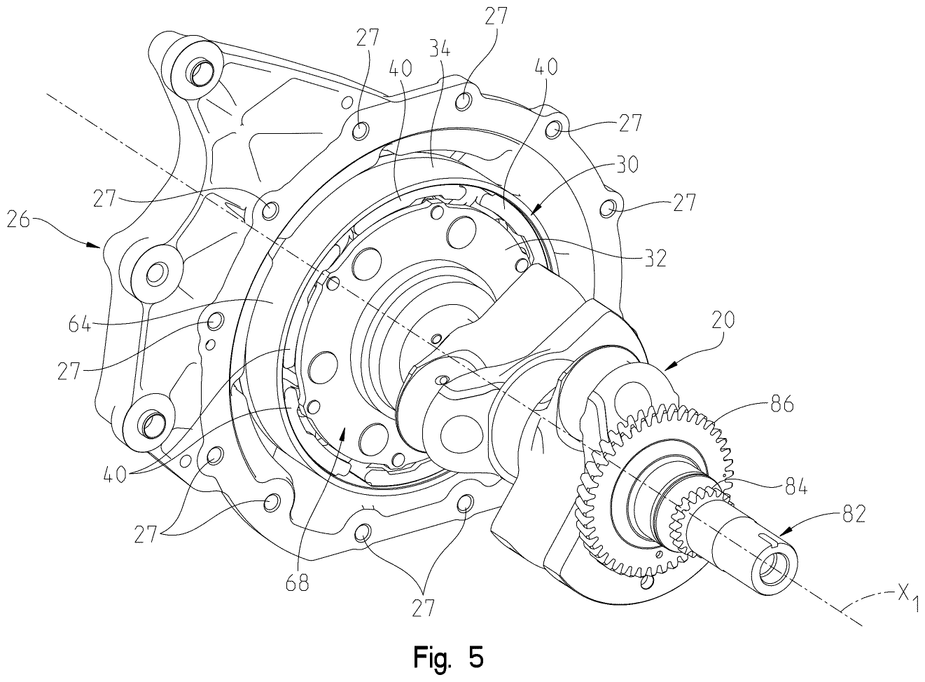

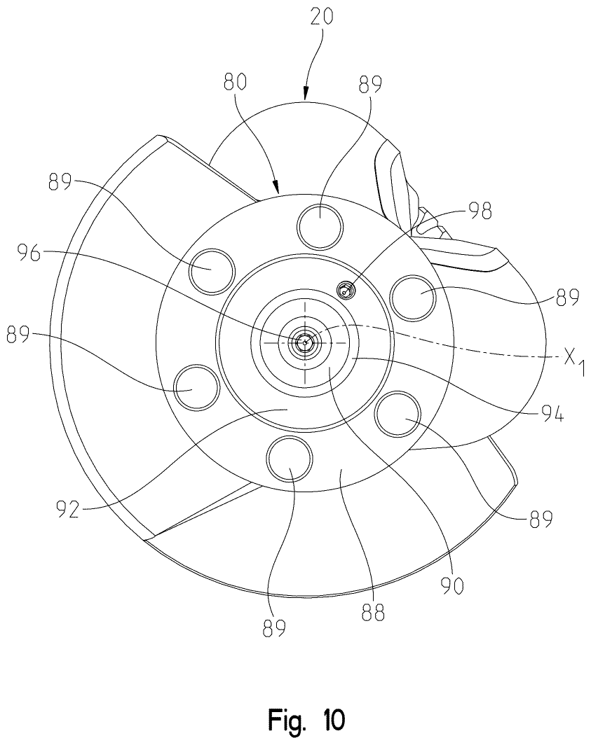

Engine 2 also includes a crankshaft 20 (FIG. 5) positioned within crankcase 3. Cylinder head 8 defines at least one cylinder (not shown) configured to receive a piston 16 (FIG. 10) configured to reciprocate within the at least one cylinder and a connecting rod (not shown) coupled between the piston and the crankshaft 20. In embodiments, engine 2 comprises one cylinder, two cylinders, three cylinders, four cylinders, or more cylinders. Referring to FIG. 4, cylinders (not shown) and crankshaft 20 extend along a longitudinal axis L. Illustratively, crankshaft 20 rotates about a rotational axis X1 (FIG. 2).

Referring still to FIGS. 1-4, engine 2 includes a cover 26 positioned along longitudinal axis L and a clutch 30 positioned within cover 26 and operably coupled to crankshaft 20. Clutch 30 includes an input member 32 and an output member 34 extending through cover 26 along rotational axis X1.

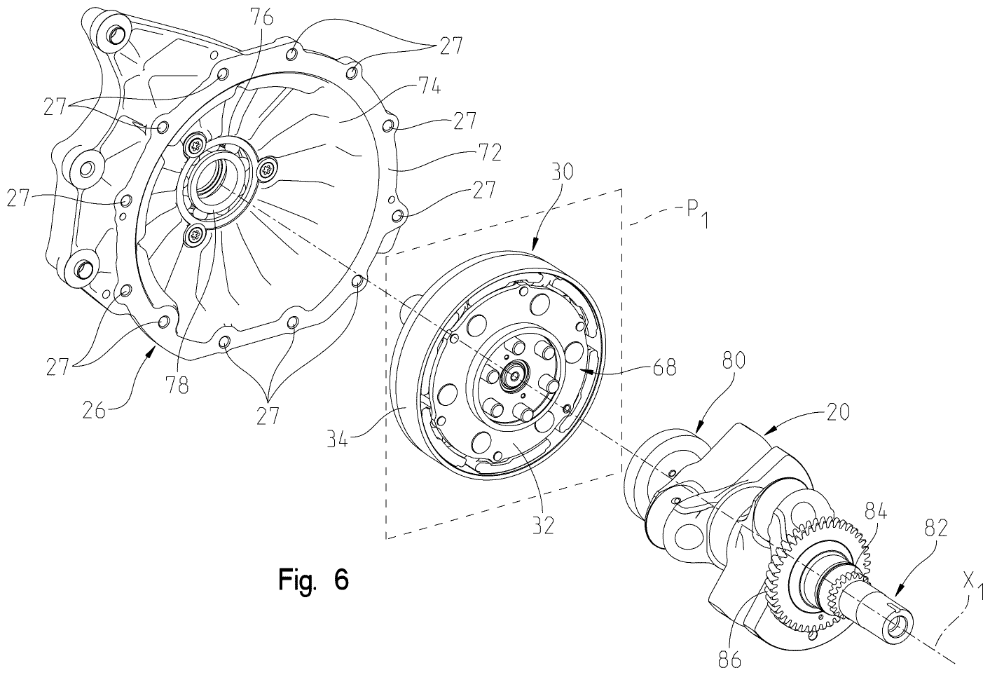

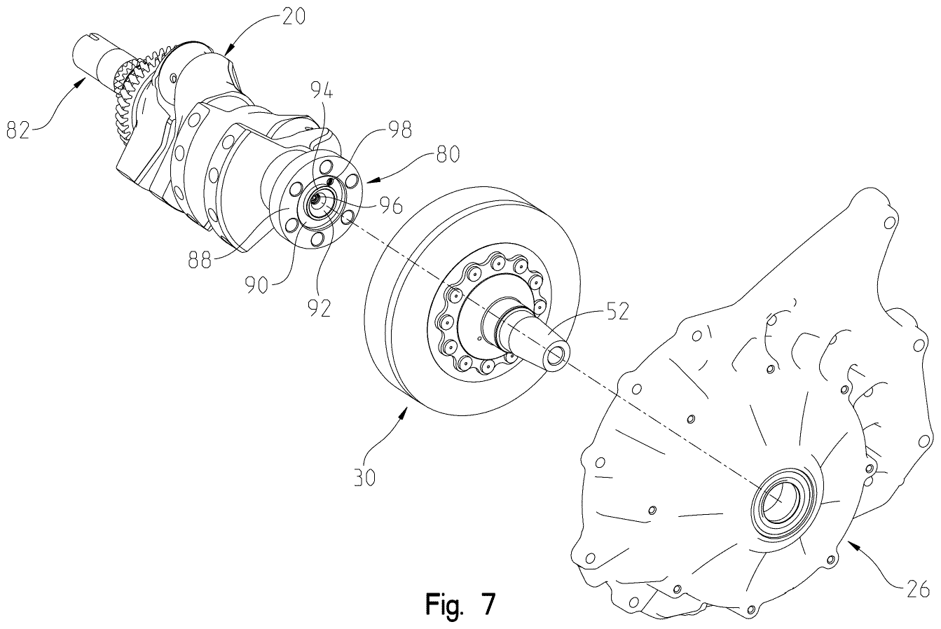

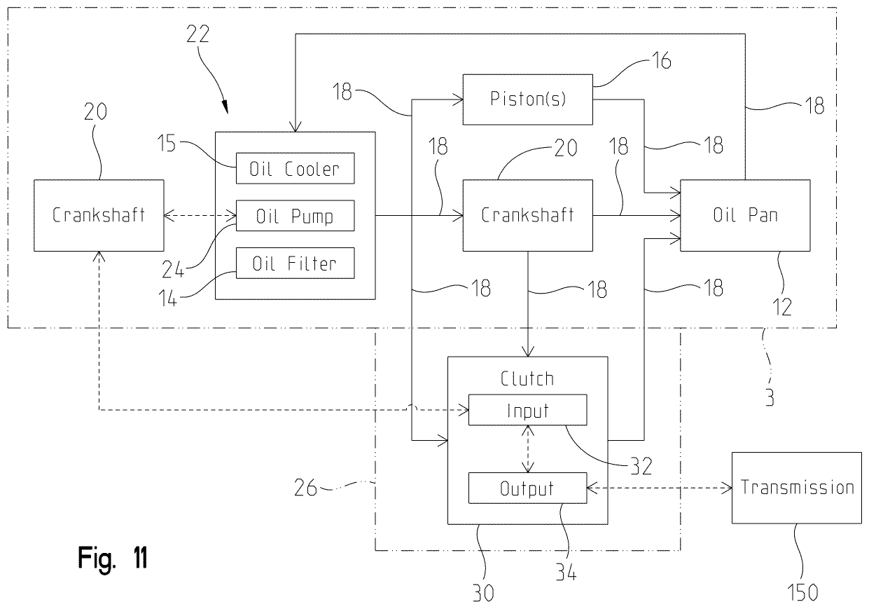

Referring now to FIGS. 5-8, cover 26 includes a outer perimeter 72, and a bell housing 74 extending outwardly from outer perimeter 72. Outer perimeter 72 defines a plurality of apertures 27 which each receive a fastener 28 (FIG. 2) to couple cover 26 to crankcase 3. Bell housing 74 defines an aperture 76 configured to receive a bearing 78. Illustratively, bearing 78 is positioned about rotational axis X1 and bearing 78 is positioned longitudinally intermediate a transmission 150 (FIG. 11) and one-way clutch member 66 and positioned longitudinally intermediate transmission 150 and bearing 48.

Referring still to FIGS. 5-8, clutch 30 is generally positioned within bell housing 74 of cover 26. Clutch 30 includes input member 32, or first clutch member 32, operably coupled to crankshaft 20 and output member 34, or second clutch member 34, operably coupled to transmission 150 (FIG. 11). In embodiments, transmission 150 is a continuously variable transmission (CVT), an electronically controlled continuously variable transmission, a steel-belt transmission, a hydraulic transmission, an automatic transmission, a manual transmission, an automatic-manual transmission, a shiftable transmission, or another type of transmission.

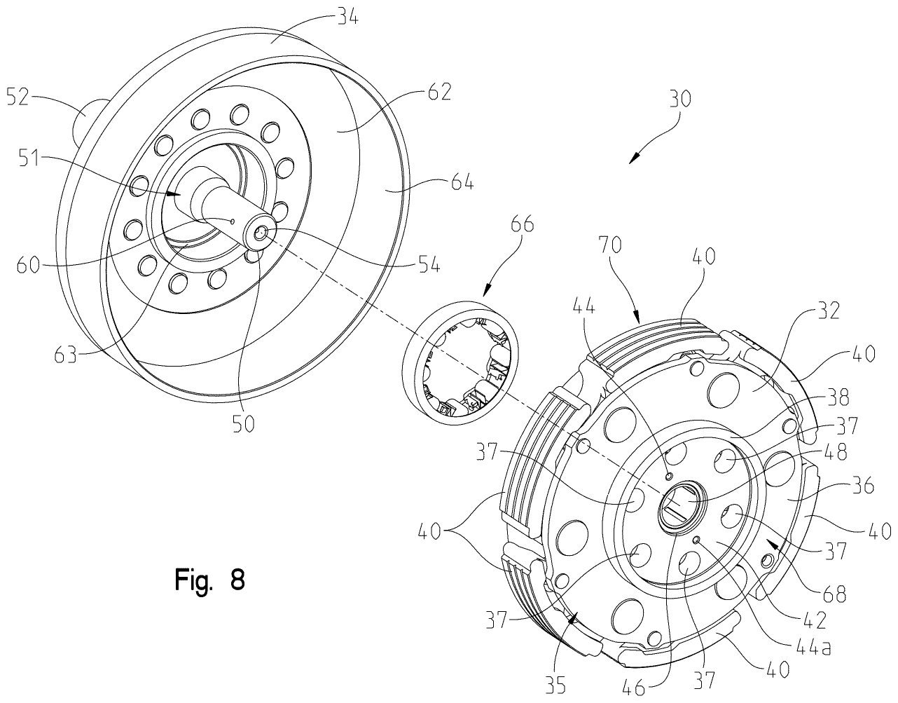

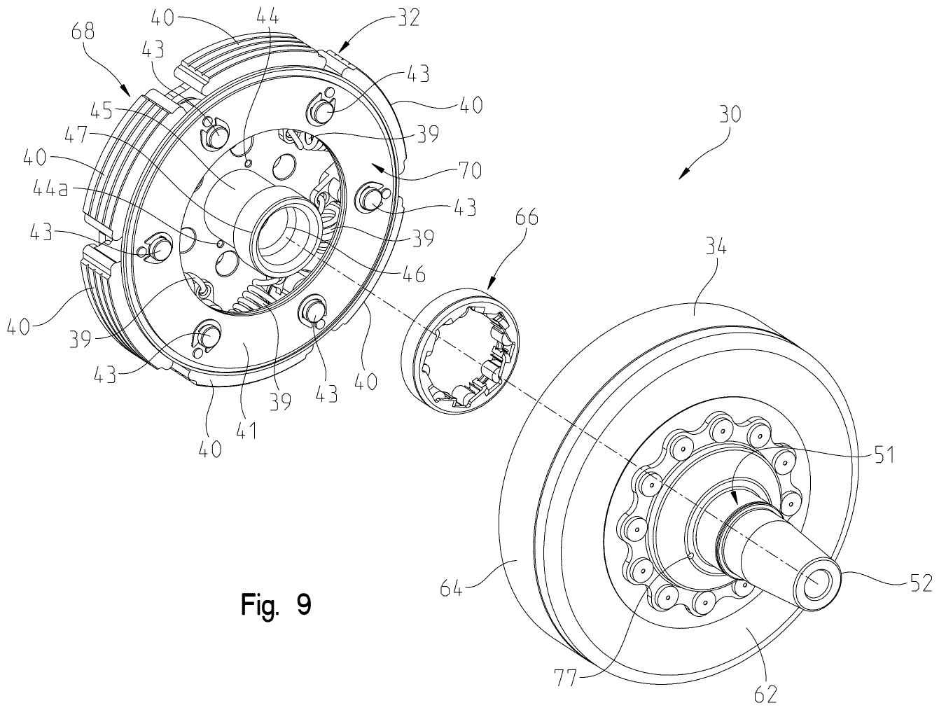

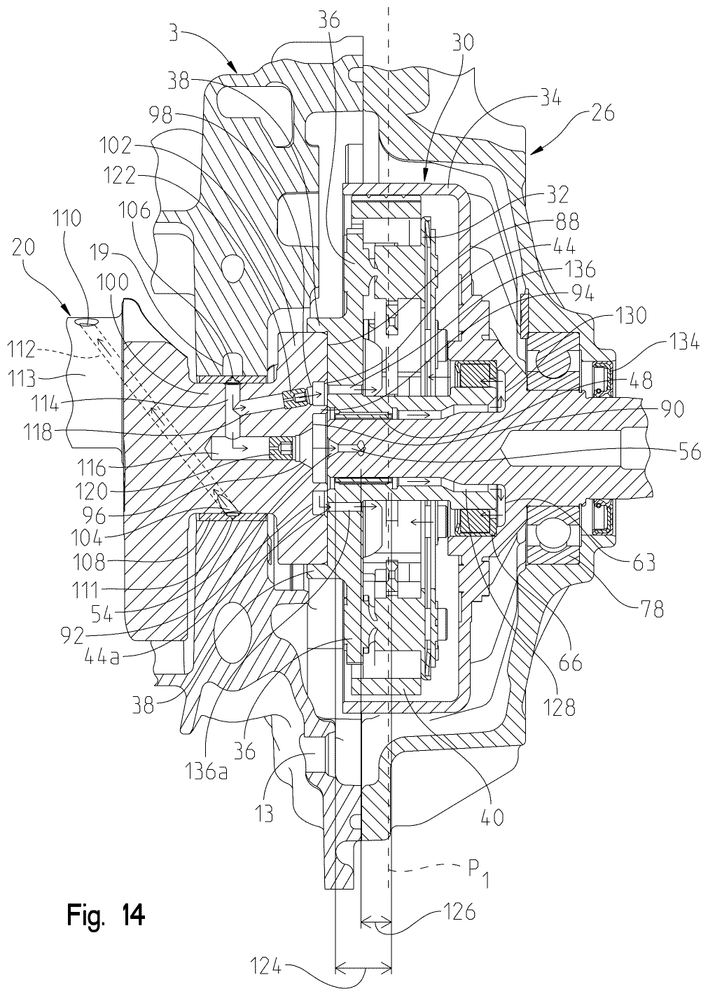

Referring to FIGS. 8-9, input member 32, or first clutch member 32 includes a hub 35 comprising an outer ring portion 36, an inner ring portion 42, and a flange 38 protruding from hub 35 and separating outer ring portion 36 and inner ring portion 42. Inner ring portion 42 of hub 35 defines a central aperture 46 and a plurality of apertures 37 radially offset from central aperture 46. A bearing 48 sits within aperture 46. Inner ring portion 42 also defines a pair of apertures 44, 44a positioned opposite of each other relative to the aperture 46. First clutch member 32 defines a pair of conduits 136, 136a (FIG. 14) extending through inner ring portion 42 and fluidly coupled to apertures 44, 44a, respectively. Hub 35 defines a first side 68 of first clutch member 32 and a second side 70 of first clutch member 32, and the flange 38 is positioned on the first side 68 of first clutch member 32. In embodiments, first side 68 of first clutch member generally faces toward engine 2 and second side 70 of first clutch member generally faces toward transmission 150 (FIG. 11) and away from engine 2. Hub 35 also includes a shaft 45 extending outwardly from second side 70 and shaft 45 includes an end portion 47. First clutch member 32 also includes a plurality of shoes 40 positioned along an outer perimeter of hub 35 on second side 70 of first clutch member 32. First clutch member 32 also includes a plurality of springs 39, or linear force elements, and a spring 39 is coupled between adjacent shoes 40 (e.g., each spring 39 is coupled between a first shoe 40 and an adjacent shoe 40). Each shoe 40 is configured to move radially inwardly and outwardly depending on the rotational speed of first clutch member 32. That is, as the rotational speed of first clutch member 32 increases, shoes 40 experience a centrifugal force, and when the centrifugal force experienced by shoes 40 exceeds the spring force of springs 39, shoes 40 move radially outwardly relative to rotational axis X1. A plate 41 is positioned generally on the second side 70 of first clutch member 32, and a plurality of fasteners 43 extend through first clutch member 32 and couple springs 39 between hub 35 and plate 41.

In embodiments, clutch 30 may be a launch clutch with a predetermined engagement speed. That is, clutch 30 is coupled intermediate engine 2 and transmission 150 (FIG. 11), and as an engine speed of engine 2 increases, clutch 30 may engage at a predetermined engine speed, at which point transmission 150 receives an input. In embodiments, engine 2, or powertrain 2, is supported by a frame (not shown), and the frame is supported by a plurality of ground engaging members (not shown). Ground engaging members may include wheels, skis, tracks, or other members. Engine 2 is coupled to the ground engaging members through clutch 30 and transmission 150.

Still referring to FIGS. 8-9, output member 34, or second clutch member 34 includes a shaft 51 including a first shaft portion 50 and a second shaft portion 52. A plate 62 extends outwardly from shaft 51 and a flange 64 extends outwardly from plate 62 generally parallel with first shaft portion 50. Plate 62 generally defines a recessed portion 63 recessed outwardly toward second shaft portion 52. First shaft portion 50 defines an inlet 54, our aperture 54 and a pair of outlets 60 (FIG. 11), or apertures 60 and the inlet 54 is fluidly coupled to outlets 60. Clutch 30 also includes a one-way clutch member 66 coupled intermediate first clutch member 32 and second clutch member 34. One-way clutch member 66 is coupled between and end portion 47 of shaft 45. One-way clutch is configured to allow second clutch member 34 to rotate relative to first clutch member 32 in a single direction. In embodiments, one-way clutch member 66 is positioned longitudinally intermediate bearing 48 and bearing 78.

Referring to FIGS. 5-10, crankshaft 20 includes a first end 80 and a second end 82 opposite the first end 80. Crankshaft 20 includes a first geared portion 84 and a second geared portion 86 positioned adjacent the second end 82. Crankshaft 20 may be supported by the crankcase 3 at each of first end 80 and second end 82. That is, first end 80 may be supported at a first longitudinal end of crankcase 3 and second end 82 may be supported by a second longitudinal end of crankcase 3 opposite the first longitudinal end. In embodiments, first geared portion 84 and/or second geared portion may be rotatably coupled to one or more of a timing chain, alternator, oil pump, compressor, water pump, or other component.

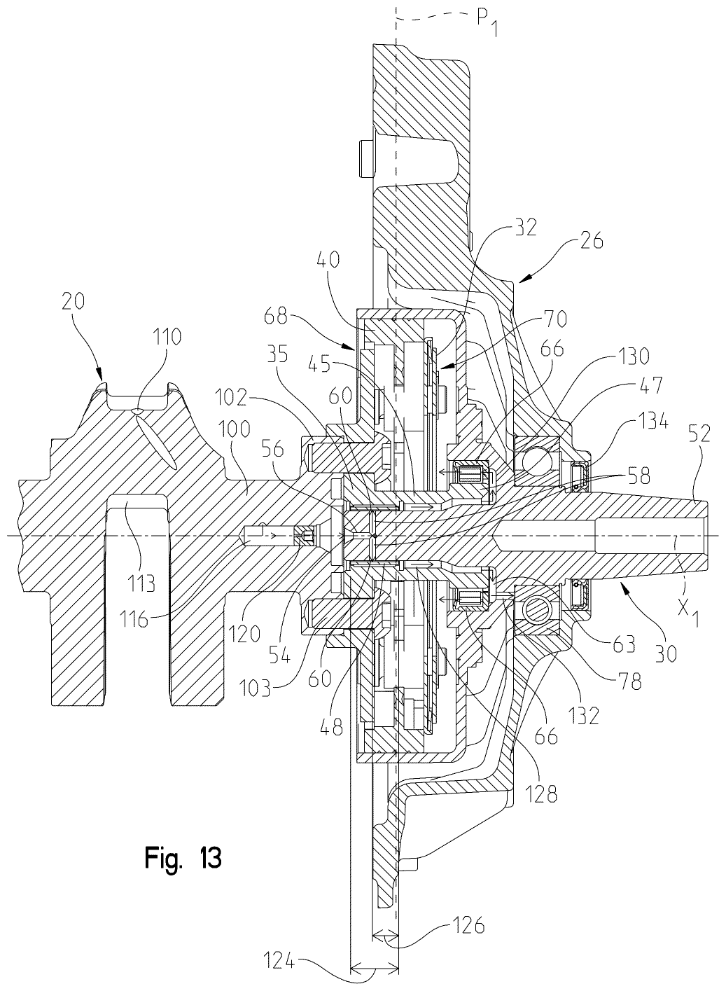

Referring now to FIGS. 10-12, first end 80 includes a collared portion 100 and a flanged portion 102. Flanged portion 102 includes a face 88 including a first recessed ring 90, a second recessed ring 92, and a flange 94 extending outwardly between first recessed ring 90 and second recessed ring 92. First recessed ring 90 defines a first aperture 96 and second recessed ring 92 defines a second aperture 98. First aperture 96 is positioned along rotational axis X1 and second aperture 98 is radially offset from first aperture 96. Face 88 also defines a plurality of apertures 89, and a plurality of fasteners 103 (FIG. 13) extend through apertures 89 and apertures 37 to couple crankshaft 20 to first clutch member 32. That is, crankshaft 20 is rotatably coupled to first clutch member 32. Further, as crankshaft 20 rotates, first clutch member 32 rotates and shoes 40 move radially outwardly and engage flange 64 of output member 34, thereby rotatably coupling first clutch member 32 to second clutch member 34. When first clutch member 32 is rotatably coupled to second clutch member 34, crankshaft 20 and transmission 150 (FIG. 11) are coupled and a rotational input to crankshaft 20 will provide rotational power to transmission 150.

Referring now to FIG. 11, engine 2 includes an oil assembly 22 comprising an oil pump 24, an oil filter 14, an oil cooler 15, and a plurality of conduits 18 (e.g., oil conduits). Oil pump 24 transports oil, or another cooling fluid, through the plurality of conduits 18 to crankshaft 20, pistons 16, and clutch 30. Oil may flow to the plurality of engine components (e.g., crankshaft 20, pistons 16, clutch 30) and into an oil pan 12. Oil pump 24 may be positioned within, or adjacent to, oil pan 12, and pump 24 may pick-up and pump oil from oil pan 12 through oil filter 14, through oil cooler 15, and through conduits 18. In various embodiments, oil pump 24 may pump oil through conduits 18 to oil filter 14, subsequently through oil cooler 15, and through conduits 18 on to crankshaft 20, pistons 16, and clutch 30. In embodiments, oil assembly 22 includes conduits 18 positioned within crankcase 3 and also includes conduits 18 positioned within cover 26. In embodiments, conduits 18 are internal conduits positioned within a wall of the crankcase 3, or wall of the cover 26. In embodiments, conduits 18 are added components positioned within cavities created by crankcase 3 or cover 26. In embodiments, oil assembly 22 provides oil to each of crankshaft 20, pistons 16, clutch 30 in any order. In embodiments, oil assembly 22 provides oil to other components within engine 2, including connecting rods, bearings, chains, valvetrains, and other engine components.

Referring now to FIGS. 11-14, a portion of oil assembly 22 is positioned within crankcase 3 and a portion of oil assembly 22 is positioned within cover 26. Crankcase 3 defines a cavity 19 surrounding at least a portion of crankshaft 20. Illustratively, cavity 19 surrounds a portion of collared portion 100. In embodiments, cavity 19 is positioned within a wall of crankcase 3. In embodiments, cavity 19 is positioned within second crankcase portion 6. Crankcase 3 defines a conduit 21 extending between a conduit 18 and cavity 19. In embodiments, a bearing 108 is coupled between collared portion 100 of crankshaft 20 and crankcase 3. That is, bearing 108 supports crankshaft 20 on crankcase 3 and allows crankshaft 20 to rotate relative to crankcase 3. Cavity 19 surrounds a portion of bearing 108, and oil flows through conduits 18, 21 to reach cavity 19 and bearing 108. Bearing 108 includes an interior channel 111 that extends circumferentially around the interior of bearing 108 and a plurality of apertures 109 extending radially through bearing 108 to fluidly couple cavity 19 with interior channel 111.

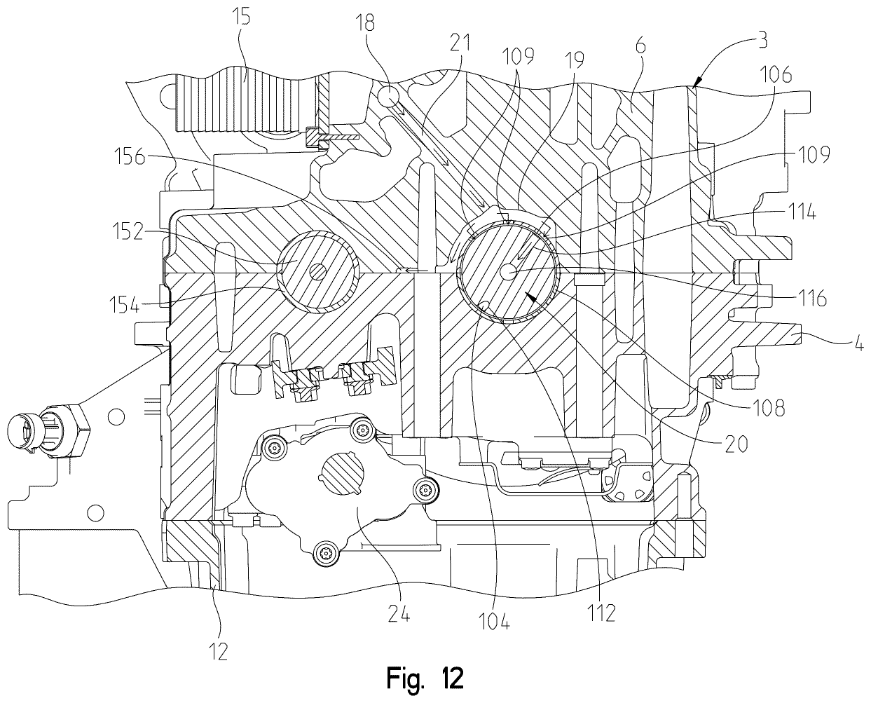

Referring to FIGS. 12-14, collared portion 100 defines an aperture 104 and an aperture 106, and channel 111 is aligned with an aperture 104 and an aperture 106. Fluid may flow through cavity 19, through apertures 109, channel 111 and through apertures 104, 106. Crankshaft 20 defines a connecting rod support portion 113 configured to support a bearing (not shown) and a connecting rod (not shown) which is coupled between crankshaft 20 and a piston 16 (FIG. 11). Connecting rod support portion 113 defines an aperture 110, and crankshaft 20 defines a conduit 112 extending between aperture 110 and aperture 104. Oil flows through aperture 104, through conduit 112, and through aperture 110 to connecting rod (not shown). Oil is able to flow outwardly away from the crankshaft rotational axis X1 due to centrifugal forces created by the rotation of crankshaft 20.

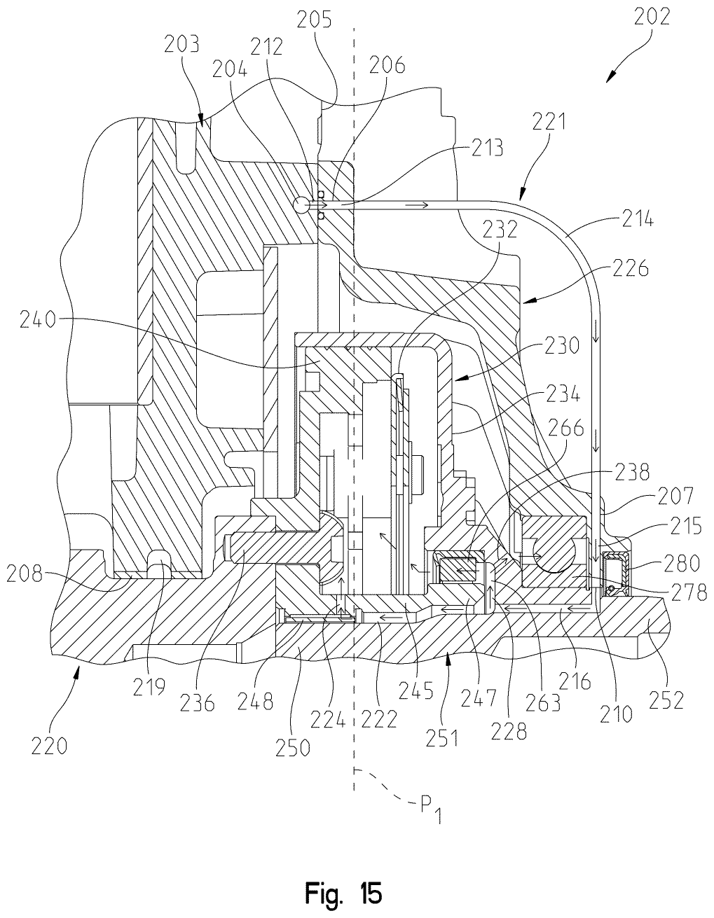

Referring now to FIG. 14, crankshaft 20 defines a conduit 114 extending radially inwardly from aperture 106 generally perpendicular to crankshaft rotational axis X1 and further defines a conduit 116 fluidly coupled to conduit 114. Conduit 116 extends generally parallel to crankshaft rotational axis X1. In embodiments, conduit 116 extends along crankshaft rotational axis X1 and conduit 116 is fluidly coupled to first aperture 96 along crankshaft rotational axis X1. A conduit 118 is fluidly coupled to conduit 114 and extends generally linearly between conduit 114 and second aperture 98. In embodiments, conduit 114 extends generally longitudinally and angled relative to crankshaft rotational axis X1. That is, conduit 114 is radially offset from crankshaft rotational axis X1 and conduit 116 and conduit 114. In embodiments, conduit 114 extends further radially outwardly as conduit 114 extends towards face 88 of crankshaft 20. Referring to FIGS. 14-15, a first nozzle 120 is positioned within first aperture 96 and extends within conduit 116 and a second nozzle 122 is positioned within second aperture 98 and extends within conduit 118. First nozzle 120 is a metered nozzle configured to alter the flow of oil through conduit 120 and second nozzle 122 is a metered nozzle configured to alter the flow of oil through conduit 118. In embodiments, first nozzle 120 and second nozzle 122 are configured to increase the velocity of the flow of oil through each nozzle, respectively, by reducing the outlet diameter (e.g., diameter of the nozzle diameter) and increasing the pressure fluidly behind each of first nozzle 120, second nozzle 122. Increasing the velocity of oil at the outlet of each of first nozzle 120 and second nozzle 122 will increase the distance oil will be jettisoned from first nozzle 120, second nozzle 122. In embodiments, first nozzle 120 and second nozzle 122 have the same outlet diameter. In embodiments, first nozzle 120 and second nozzle have different sized outlet diameters. In embodiments, first nozzle 120 is configured to output a higher volumetric flow rate of oil than second nozzle 122. In embodiments, second nozzle 122 is configured to output a higher volumetric flow rate of oil than first nozzle 120. In embodiments, first nozzle 120 and second nozzle 122 are threaded within conduit 116 and conduit 118, respectively. In embodiments, first nozzle 120 and second nozzle 122 are coupled within conduit 116, 118 with an adhesive. In embodiments, first nozzle 120 and second nozzle 122 are integral with crankshaft 20 within conduits 116, 118, respectively. In embodiments, first nozzle 120 is configured to direct fluid along a path generally parallel to crankshaft rotational axis X1 and second nozzle 122 is configured to direct fluid along a path angled relative to crankshaft rotational axis X1.

Still referring to FIGS. 13-14, shaft 51 of output member 34 defines a first conduit 56 fluidly coupled to inlet 54. First conduit 56 extends generally longitudinally along crankshaft rotational axis X1 within shaft 51. In embodiments, bearing 48 is positioned generally at a longitudinal extent of first shaft portion 50 of shaft 51 adjacent crankshaft 20. In embodiments, a pair of conduits 58 extend between first conduit 56 and outlets 60. The pair of conduits 58 are diametrically opposed and extend approximately 180 degrees from each other. In embodiments, conduits 58 are generally a single conduit extending diametrically through first shift portion 50 of shaft 51 between outlets 60. In embodiments, outlets 60 are positioned generally aligned with a longitudinal center of bearing 48. That is, oil is configured to flow through inlet 54, through conduit 56, through each of conduits 58 and through outlets 60 and contact bearing 48 at an approximate longitudinal center of bearing 48. In embodiments, bearing 48 has a first length 124 and outlets 60 are positioned a second length 126 from a longitudinal end of bearing 48. In embodiments, second length 126 is approximately 50% of first length 124. In embodiments, second length 126 is approximately 30-70% of first length 124. In embodiments, second length 126 is approximately 10-90% of first length 124.

Still referring to FIGS. 13-14, first shaft portion 50 of shaft 51 is separated (e.g., radially spaced) from shaft 45 of input member 32 by a conduit 128, or cavity 128. Further, recessed portion 63 of output member 34 is separated (e.g., longitudinally spaced) from end portion 47 of input member 32 by a conduit 130. Conduit 130, or cavity 130 extends radially outwardly from conduit 128, and conduit 130 is configured to direct fluid (e.g., oil) toward one-way clutch member 66. Fluid (e.g., oil) flows through one-way clutch member 66 to lubricate and cool one-way clutch member 66 and further flows, or is directed toward second side 70 of first clutch member 32 of clutch 30. Further, recessed portion 63 of input member 32 defines a conduit 132 extending generally longitudinally between conduit 130 toward bearing 78. That is, fluid (e.g., oil) flows from conduit 130 into conduit 132, directed toward and through bearing 78 to lubricate and cool bearing 78. A retainer 134, or seal 134, is positioned within cover 26, between shaft 51 and cover 26, to fluidly seal clutch 30 within cover 26.

Referring now to FIG. 14, fluid flows through conduit 118, through second nozzle 122, and into aperture 44 and through conduit 136 of input member 32. Fluid (e.g., oil) flows through aperture 44 and conduit 136 and onto first side 68 of first clutch member 32 of clutch 30. In embodiments, a vertical plane Pl extends through clutch 30 and oil assembly 22 extends across plane P1. In embodiments, vertical plane P1 extends through first clutch member 32 of clutch 30 and oil assembly 22 extends across plane P1. In embodiments, a first fluid path is defined by fluid (e.g., oil) flowing into conduit 114, through conduit 116, through first nozzle 120 out of first aperture 96 within crankshaft 20 to inlet 54 of shaft 51, through first conduit 56 and conduits 58 and out of outlets 60, through bearing 48, through conduit 128, 130, through conduit 132 to bearing 78, and through conduit 130 to one-way clutch member 66 and to second side 70 of first clutch member 32 of clutch 30. In embodiments, a second fluid path is defined by fluid (e.g., oil) flowing into conduit 114, through conduit 118, through second nozzle 122 out of second aperture 98 within crankshaft 20 to aperture 44 and conduit 136 within input member 32 onto first side 68 of first clutch member 32 of clutch 30. That is, the first fluid path flows fluid (e.g., oil) toward a first side of clutch 30 (e.g., second side 70 of first clutch member 32) and the second fluid path flows fluid (e.g., oil) toward a second side of clutch 30 (e.g., first side 68 of first clutch member 32).

Referring still to FIG. 14, crankshaft 20 and input member 32 of clutch 30 are rotatably coupled, and therefore, second aperture 98 of crankshaft 20 is aligned with aperture 44 of input member 32. Aperture 44a is aligned with second recessed ring 92. Flange 94 separates first recessed ring 90 and second recessed ring 92, and prevents or mitigates any excess fluid (e.g., oil) from second aperture 98 from reaching or entering aperture 44 of input member 32 In embodiments, flange 94 separates first recessed ring 90 and second recessed ring 92 and fluid (e.g., oil) that enters first recessed ring 90 remains in first recessed ring 90 or enters conduit 56 through inlet 54 and fluid that enters second recessed ring 92 remains in second recessed ring 92 or enters conduits 136, 136a through inlets 44, 44a respectively.

In embodiments, the first fluid path is configured to provide fluid (e.g., oil) to at least one of the bearing 48, one-way clutch 66, bearing 78, and clutch 30. In embodiments, the second fluid path is configured to provide fluid (e.g., oil) to only the clutch 30. In embodiments, the first fluid path is configured to provide fluid (e.g., oil) to at least two of the bearing 48, one-way clutch 66, bearing 78, and clutch 30. In embodiments, the first fluid path is configured to provide fluid (e.g., oil) to each of the bearing 48, one-way clutch 66, bearing 78, and clutch 30. In embodiments, the second fluid path may provide more fluid (e.g., oil) to the clutch 30 than the first fluid path. In embodiments, the first fluid path may provide fluid (e.g., oil) to each of bearing 48, one-way clutch 66, bearing 78, and remaining amounts of fluid (e.g., oil) may flow toward or come into contact with clutch 30.

Referring now to FIGS. 15-20 alternative systems for providing fluid (e.g., oil) to various components of clutch 30 are provided, including bearing 48, one-way clutch member 66, bearing 78, and first side 68 and second side 70 of first clutch member. Alternative oiling systems provided in FIGS. 15-20 may be instituted alone, or in combination with each other, or in combination with oil assembly 22.

Referring now to FIG. 15, an engine 202, or powertrain 202 is substantially similar to engine 2 and includes a crankcase 203, a crankshaft 220 supported by the crankcase 203, and a cover 226 coupled to the crankcase. In embodiments, crankcase 203 defines a cavity 219. A bearing 208 is coupled between crankcase 203 and crankshaft 220 and bearing 208 supports crankshaft 220. In embodiments, bearing 208 is fluidly coupled with cavity 219 and bearing 208 may be cooled by fluid flowing through cavity 219 to bearing 208. A clutch 230 is operably coupled between the crankshaft 220 and a transmission (not shown, e.g., transmission 150 (FIG. 11)). Clutch 230 includes an input member 232, or first clutch member 232, and an output member 234, or second clutch member 234. First clutch member 232 is rotatably coupled to crankshaft 220 by a plurality of fasteners 236 and first clutch member 232 includes a plurality of shoes 240 moveable in a radial direction relative to a crankshaft rotational axis (e.g., rotational axis X1). Shoes 240 are configured to couple with second clutch member 234 as the rotational speed of first clutch member 232 increases.

Still referring to FIG. 15, second clutch member 234 includes a shaft 251 defining a first shaft portion 250 and a second shaft portion 252. Second clutch member 234 also defines a recessed portion 263. First clutch member 232 includes a shaft 245 extending outwardly from crankshaft 220 and shaft 245 defines a flanged end 247. A bearing 248 (similar to bearing 48) is coupled between first clutch member 232 and second clutch member 234, and in embodiments, bearing 248 is coupled between first shaft portion 250 and shaft 245. A one-way clutch member 266 (similar to one-way clutch member 66) is coupled between first clutch member 232 and second clutch member 234, and in embodiments, one-way clutch member 266 is coupled between recessed portion 263 of second clutch member 234 and flanged end 247 of shaft 245. A bearing 278 is coupled between shaft 251 and cover 226 to support shaft 251 on cover 226.

Referring still to FIG. 15, engine 202 includes an oil assembly 221 which may be substantially similar to oil assembly 22. Shaft 251 of second clutch member 234 is separated (e.g., radially offset) from shaft 245 of first clutch member 232, and a conduit 222 is created between shaft 251 and shaft 245. First clutch member 232 defines a conduit 224 and conduit 224 extends upwardly from bearing 248 away from shaft 51, generally perpendicular to crankshaft rotational axis X1. In embodiments, conduit 224 is longitudinally aligned with a portion of bearing 248. In embodiments, shaft 245 defines a plurality of conduits extending upwardly through shaft 245 from conduit 222. Recessed portion 263 of second clutch member 234 is separated (e.g., longitudinally offset) from flanged end 247 of first clutch member 232, and a conduit 228 is created between recessed portion 263 and flanged end 247. Conduit 228 is extending between and fluidly coupled between conduit 222 and one-way clutch member 266. Second clutch member 234 defines a conduit 238 extending between, and fluidly coupled between conduit 228 and bearing 278. Second clutch member 234 defines a conduit 216 and an aperture 210 positioned adjacent bearing 278 and a retainer 280 (similar to retainer 134). Conduit 216 is fluidly coupled to and extends between conduit 222 and aperture 210.

Crankcase 203 defines a conduit 204 which is operably coupled to a plurality of conduits (not shown, e.g., conduits 18) of the oil assembly 221. In embodiments, conduit 204 is internal to crankcase 203. Crankcase 203 also defines a conduit 212, and conduit 212 is fluidly coupled between conduit 204 and an outer face 205 of crankcase 203. Cover 226 defines a first portion 206 defining a first conduit 213 and a second portion 207 defining a second conduit 215. Conduit 213 aligns with and is fluidly coupled with conduit 212 and conduit 215 aligns with and is fluidly coupled with conduit 216. A conduit 214, or tube 214, extends between first portion 206 and second portion 207. In embodiments, conduit 214 extends within, or is a part of, conduit 213, conduit 215, such that a continuous unitary conduit extends between crankcase outer face 205 at conduit 212 and conduit 216 at aperture 210. In embodiments, conduit 214 is coupled between first portion 206 at conduit 213 and second portion 207 at second conduit 215. In embodiments, conduits 213, 215 define threads and conduit 214 is threaded into each of conduits 213, 215. In embodiments, cover 226 is larger and encapsulates the entirety of conduit 214. That is, in embodiments, conduit 214 is positioned completely within cover 226. In embodiments, cover 226 defines a channel (not shown) that operates substantially similar to conduit 214.

Still referring to FIG. 15, fluid (e.g., oil) flows through oil conduits (e.g., conduits 18) to conduit 204. Fluid flows through conduit 212 and into first portion 206 of cover 226 and into conduit 214, and the fluid flows through conduit 214 external to either of crankcase 3 and cover 226, and flows back into second portion 207 of cover 226. Fluid flows from conduit 215 into conduit 216 and into each of conduit 222 and conduit 228. Fluid flows through conduit 222, through bearing 248 to lubricate and cool bearing 248, and outwardly through conduit 224 radially outwardly toward clutch 230 (e.g., first clutch member 232). Fluid flows through conduit 228, through conduit 238 to bearing 278 to lubricate and cool bearing 278. Fluid flows through conduit 228 to one-way clutch member 266 to lubricate and cool one-way clutch member 266, and fluid (e.g., oil) flows through one-way clutch member 266 and is directed toward clutch 230 (e.g., first clutch member 232). Plane PI extends vertically through clutch 30 (e.g., first clutch member 232), and oil conduit 214 extends across plane P1.

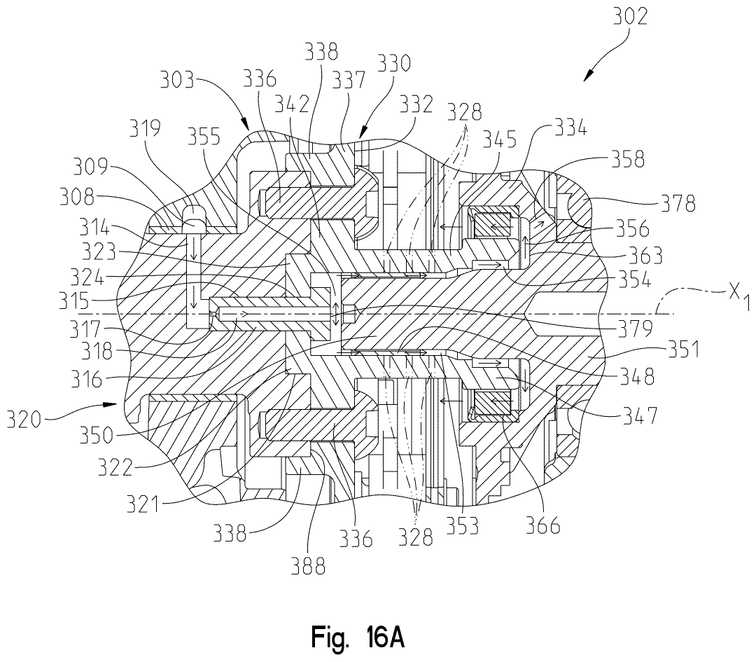

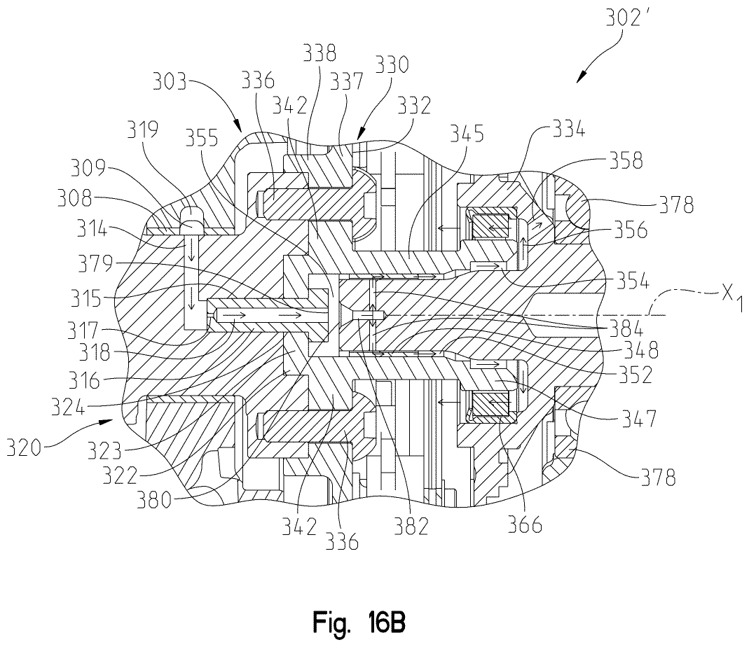

Referring now to FIGS. 16A-16B, an engine 302, or powertrain 302 is substantially similar to engine 2 and includes a crankcase 303, a crankshaft 320 supported by the crankcase 303, and a cover (not shown) coupled to the crankcase 303. A bearing 308 is coupled between crankcase 303 and crankshaft 320 and bearing 308 supports crankshaft 320. A clutch 330 is operably coupled between the crankshaft 320 and a transmission (not shown, e.g., transmission 150 (FIG. 11)). Clutch 330 includes an input member 332, or first clutch member 332, and an output member 334, or second clutch member 334. First clutch member 332 includes a hub 322 and a plate member 337 extending outwardly from the hub 322. Plate member 337 defines an inner ring 342 and a flange 338 extending longitudinally outwardly toward crankcase 303. In embodiments, hub 322 defines a base 323 and base 323 defines an aperture 324 longitudinally aligned with crankshaft 320. A shaft 345 extends outwardly from inner ring 342 longitudinally toward transmission 150. Shaft 345 defines a flanged portion 347. A plurality of fasteners 336 extend through inner ring 342 of plate member 337 to couple first clutch member 332 to crankshaft 320.

Still referring to FIGS. 16A-16B, a lateral end of crankshaft 320 defines a face 388 (similar to face 88), and face 388 defines a recessed portion 321. In embodiments, hub 322 is positioned within recessed portion 321 and radially inwardly of inner ring 342. In embodiments, shaft 345 extends longitudinally outwardly from inner ring 342 along crankshaft rotational axis X1. In embodiments, flanged portion 347 extends outwardly from shaft 345. In embodiments, shaft 345 defines a plurality of conduits 328 extending radially outwardly through shaft 345 from crankshaft rotational axis X1. Crankshaft 320 defines a recess 315 extending along crankshaft rotational axis X1, and a fastening member 316 (e.g., a bolt) extends through aperture 324 and recess 315 and hub 322 is coupled with crankshaft 320.

Still referring to FIGS. 16A-16B, second clutch member 334 includes a shaft 351 including a first shaft portion 350 positioned adjacent crankshaft 320 and a second shaft portion 352 positioned adjacent a transmission (not shown, e.g., transmission 150 (FIG. 11)). Illustratively, second shaft portion 352 is operably coupled to transmission (e.g., transmission 150). Further, second clutch member 334 includes a recessed portion 363 extending radially outwardly from shaft 351.

Referring still to FIGS. 16A-16B, crankcase 3 defines a cavity 319 fluidly coupled to a plurality of oil conduits (e.g., oil conduits 318). A bearing 308 is positioned between crankshaft 320 and crankcase 303 and bearing 308 defines a plurality of apertures 309. Cavity 319 is fluidly coupled to apertures 309. Crankshaft defines a conduit 314, and apertures 309 allow fluid to pass through bearing 308 into conduit 314. Fastener 316 includes a first aperture 317, a second aperture 379, and a conduit 318 extending between aperture 317 and aperture 379. Fluid (e.g., oil) flows to cavity 319 (e.g., from an oil pump, not shown, similar to oil pump 24), through bearing 308, through conduit 314, through aperture 317, and through conduit 318.

Referring now to FIG. 16A, fastening member 316 is separated from shaft 351 (e.g., longitudinally spaced) and a cavity 355 is created between fastening member 316 and shaft 351. Fluid (e.g., oil) flows through oil conduits 318, through second aperture 379, and into cavity 355. Shaft 351 is separated from shaft 345 by a first conduit portion 353 and shaft 351 is separated from flanged portion 347 by a second conduit portion 354. Recessed portion 363 is separated (e.g., longitudinally separated) from flanged portion 347 by a third conduit portion 356, and second clutch member 334 defines a fourth conduit portion 358 extending between third conduit portion 356 and bearing 378. Third conduit portion 358 extends toward and directs fluid toward one-way clutch member 366. Fluid flows toward shaft 351 and disperses around shaft 351 and into conduit 353 and on to conduit 354. Fluid then flows through conduit 356, through conduit 358 to lubricate and cool bearing 378, and fluid flows through conduit 356 to one-way clutch member 366 to lubricate and cool one-way clutch member 366 and through one-way clutch member 366 to first clutch member 332 of clutch 330. Fluid flows through conduit 353 and radially outwardly from crankshaft rotational axis X1 through conduits 328 to lubricate and cool components of clutch 330 (e.g., plate 337, shoes, springs, etc.).

Referring now to FIG. 16B, an engine 302′ may be substantially similar to engine 302. Fastener 316 is separated from shaft 351 (e.g., longitudinally spaced) and cavity 355 is created between fastening member 316 and shaft 351. Fluid (e.g., oil) flows through oil conduits 318, through second aperture 379, and into cavity 355. Shaft 351 defines an aperture 380 (similar to aperture 54) and a conduit 382 (similar to conduit 56) fluidly coupled to aperture 380. Shaft 352 defines a pair of conduits 384 (similar to conduits 58) which extend radially outwardly from conduit 382 toward bearing 348. Shaft portion 350 is separated from shaft 345 by a first conduit portion 353 and shaft portion 350 is separated from flanged portion 347 by a second conduit portion 354. Recessed portion 363 is separated (e.g., longitudinally separated) from flanged portion 347 by a third conduit portion 356, and second clutch member 334 defines a fourth conduit portion 358 extending between third conduit portion 356 and bearing 378. Third conduit portion 358 extends toward and directs fluid toward one-way clutch member 366. Fluid (e.g., oil) flows toward shaft 351 and flows into aperture 380 and through conduit 382, through conduits 384, and onto bearing 348. Fluid (e.g., oil) flows through bearing 348 to lubricate and cool bearing 348, through conduit 353, and through conduit 354. Fluid then flows through conduit 356, through conduit 358 to lubricate and cool bearing 378, and fluid flows through conduit 356 to one-way clutch member 366 to lubricate and cool one-way clutch member 366 and through one-way clutch member 366 to first clutch member 332 of clutch 330.

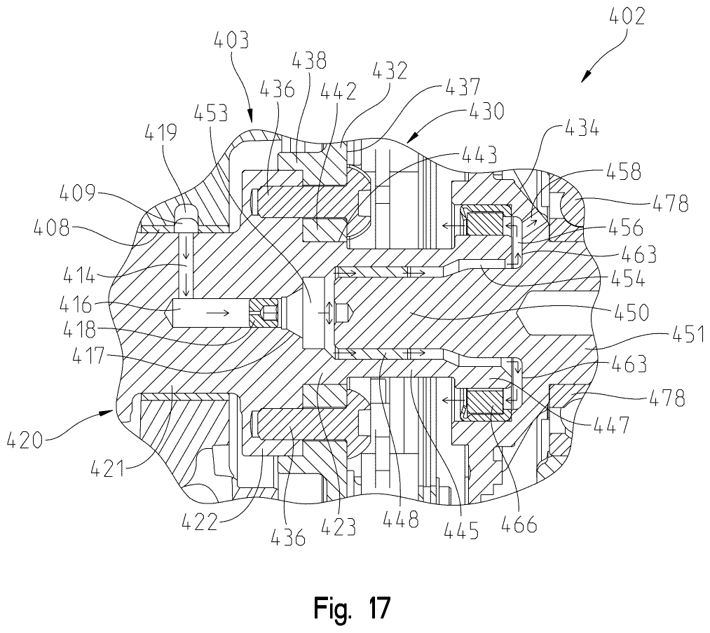

Referring now to FIG. 17, an engine 402, or powertrain 402 may be substantially similar to engine 2. Engine 402 includes a crankcase 403, a crankshaft 420 supported by the crankcase 403, and a cover (not shown) coupled to the crankcase. A bearing 408 is coupled between crankcase 403 and crankshaft 420 and bearing 408 supports crankshaft 420. A clutch 430 is operably coupled between the crankshaft 420 and a transmission (not shown, e.g., transmission 150 (FIG. 11)). Clutch 430 includes an input member 432, or first clutch member 432, and an output member 434, or second clutch member 434. First clutch member 432 includes a plate member 437 defining an inner ring 442 including an aperture 443 and a flange member 438 positioned radially outwardly from inner ring 442 and extending toward crankcase 403. A plurality of fasteners 436 extend through inner ring 442 of plate member 437 to couple plate member 437 of first clutch member 432 to crankshaft 420.

Crankshaft 420 includes a collared portion 421 supported by crankcase 403 and a bearing 408 is coupled between collared portion 421 and crankcase 403. Bearing 408 defines a plurality of apertures 409. Crankshaft 420 includes a flanged portion 422 positioned outwardly from crankcase 403. Crankshaft 420 includes an extension 423 outwardly from flanged portion 422, and a shaft 445 extends outwardly from extension 423 toward transmission 150 (FIG. 11). Shaft 445 defines a flanged portion 447 extending outwardly from shaft 445 toward transmission 150. That is, shaft 445 and flanged portion 447 are integral with crankshaft 420. Flanged portion 422 of crankshaft 420 defines an aperture 417 positioned along crankshaft rotational axis X1 and generally facing toward transmission 150. Crankshaft 420 defines a conduit 416 extending longitudinally along crankshaft rotational axis and fluidly coupled to aperture 417. A nozzle 418 is positioned within conduit 416 adjacent aperture 417. Further, collared portion 421 of crankshaft 420 defines a conduit 414 extending generally radially between bearing 408 and conduit 416. Fluid (e.g., oil) may flow into cavity 419 from a plurality of conduits (not shown, e.g., conduits 18) and from an oil pump (not shown, e.g., pump 24). Fluid may flow from cavity 419 through aperture 409 of bearing 408 into conduit 414. Fluid flows through conduit 414, and through conduit 416 to nozzle 418. In embodiments, nozzle 418 is a metered nozzle configured to increase pressure of the fluid flow.

Referring still to FIG. 17, second clutch member 434 includes a shaft 451 including a first shaft portion 450 positioned adjacent crankshaft 420 and a second shaft portion (not shown, similar to second shaft portion 52 (FIG. 13)) positioned opposite first shaft portion 450. In embodiments, shaft 451 is operably coupled to the transmission 150 (FIG. 11). Second clutch member 434 defines a recessed portion 463 extending radially outwardly from shaft 451. A bearing 478 is operably coupled between shaft 451 of second clutch member 434 and cover (not shown). Further, a bearing 448 is operably coupled between shaft 451 of second clutch member 434 and shaft 445 of crankshaft 420. A one-way clutch member 466 is coupled between crankshaft 420 and second clutch member 434. That is, one-way clutch member 466 is coupled between flanged portion 447 of crankshaft 420 and second clutch member 434.

Still referring to FIG. 17, shaft 451 is separated from (e.g., longitudinally spaced from) aperture 417 of crankshaft 420 by a cavity 453. Further, shaft 451 is separated from (e.g., radially spaced from) shaft 445 of crankshaft 420 by conduit 454. Further, recessed portion 43 is separated from (e.g., longitudinally spaced from) flanged portion 447 by conduit 456, and conduit 456 extends between conduit 454 and one-way clutch member 466. Second clutch member 434 defines a conduit 458 extending between conduit 456 and bearing 478.

Referring still to FIG. 17, fluid (e.g., oil) may flow into cavity 419, through bearing 408, through conduits 414, 416, and through nozzle 418. Fluid flows through nozzle 418, across cavity 453, and disperses around shaft 451 into conduit 454. Fluid flows across bearing 448, lubricating and cooling bearing 448, and through conduit 454 to conduit 456. Fluid flows through conduit 456 to one-way clutch member 466, cooling and lubricating one-way clutch member 466. Fluid also flows through one-way clutch member 466 to clutch 430 to cool components of clutch 30 (e.g., shoes, springs, etc.). Further, fluid flows from conduit 456 to conduit 458 on to bearing 478 to cool and lubricate bearing 478.

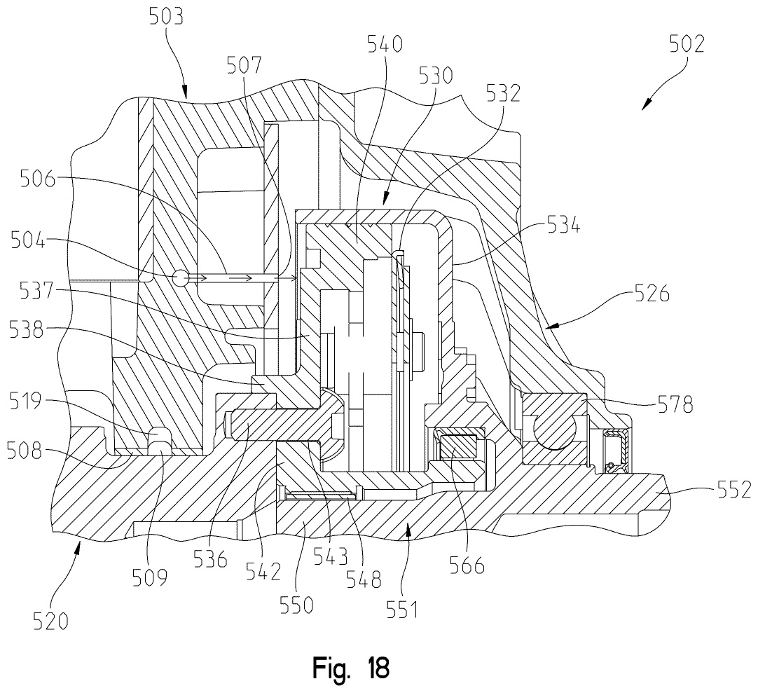

Referring now to FIG. 18, an engine 502, or powertrain 502 may be substantially similar to engine 2. Engine 502 includes a crankcase 503, a crankshaft 520 supported by the crankcase 503, and a cover 526 coupled to the crankcase. A bearing 508 is coupled between crankcase 503 and crankshaft 520 and bearing 508 supports crankshaft 520. A clutch 530 is operably coupled between the crankshaft 520 and a transmission (not shown, e.g., transmission 150 (FIG. 11)). Clutch 530 includes an input member 532, or first clutch member 532, and an output member 534, or second clutch member 534. First clutch member 532 includes a plate member 537 defining an inner ring 542 including an aperture 543 and a flange member 538 positioned radially outwardly from inner ring 542 and extending toward crankcase 503. First clutch member 532 includes a plurality of shoes 540 coupled to plate member 537 and configured to move radially outwardly to couple with second clutch member 534. A plurality of fasteners 536 extend through apertures 543 of inner ring 542 of plate member 537 to couple plate member 537 of first clutch member 532 to crankshaft 520. Second clutch member 534 includes a shaft 551 including a first shaft portion 550 and a second shaft portion 552. A bearing 548 is coupled between shaft 551 and first clutch member 532. A one-way clutch member 566 is coupled between first clutch member 532 and second clutch member 534. Further, a bearing 578 is coupled between shaft 551 of second clutch member 534 and cover 526.

Still referring to FIG. 18, crankcase 503 defines a conduit 504 fluidly coupled to a plurality of conduits (not shown, e.g., conduits 18). Crankcase 503 defines an aperture 507, and a conduit 506 extends between conduit 504 and aperture 507. Fluid (e.g., oil) is configured to flow from a pump (e.g., oil pump 24) through conduits (e.g., conduits 18) through conduit 504, and through conduit 506, and out of aperture 507. Aperture 507 is directed at clutch 30 such that fluid flow (e.g., oil) is directed at first clutch member 532 of clutch 530 to lubricate and cool clutch components (e.g., shoes, springs, etc.). In embodiments, fluid may be flowed through crankshaft 20 and shaft 551 to reach one or more conduits to flow over one or more of bearings 548, 578 and one-way clutch 566 (e.g., fluid flow for engine 2, 302, 302′). In embodiments, fluid may be flowed another way to reach one or more of conduits to flow over one or more of bearings 548, 578, and one-way clutch 566 (e.g., fluid flow for engine 202).

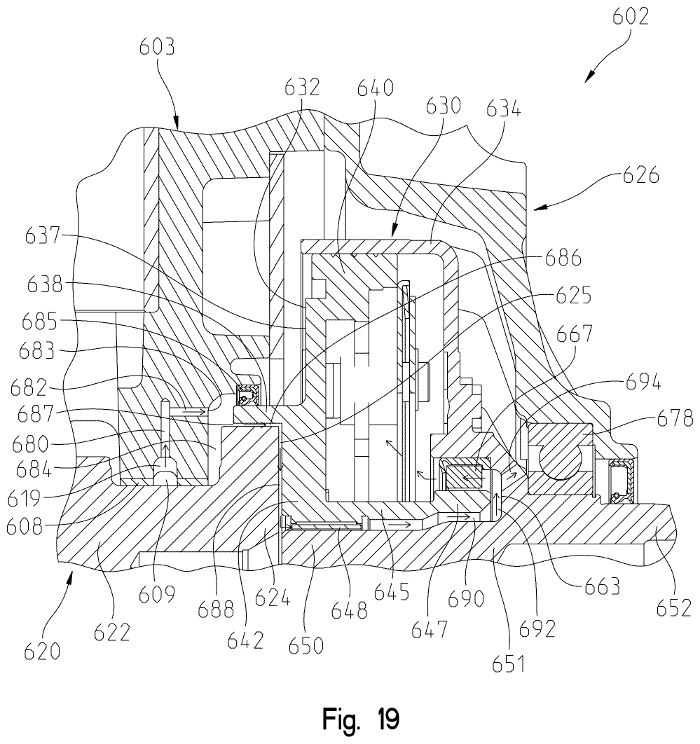

Referring now to FIG. 19 an engine 602, or powertrain 602 may be substantially similar to engine 2. Engine 602 includes a crankcase 603, a crankshaft 620 supported by the crankcase 603, and a cover 626 coupled to the crankcase 603. Crankshaft 620 defines a collared portion 622 and a flanged portion 624 extending outwardly from collared portion 622. A bearing 608 is coupled between crankcase 603 and crankshaft 620 and bearing 608 supports crankshaft 620. A clutch 630 is operably coupled between the crankshaft 620 and a transmission (not shown, e.g., transmission 150 (FIG. 11)). Clutch 630 includes an input member 632, or first clutch member 632, and an output member 634, or second clutch member 634. First clutch member 632 includes a plate member 637 defining an inner ring 642 and a flange member 638 positioned radially outwardly from inner ring 642 and extending toward crankcase 603. First clutch member 632 includes a plurality of shoes 640 coupled to plate 637 and configured to movie radially outwardly to couple with second clutch member 634. A plurality of fasteners (not shown) extend through inner ring 642 of plate member 637 to couple plate member 637 of first clutch member 632 to crankshaft 620. First clutch member 632 also includes a shaft 645 extending outwardly from inner ring 642, generally away from crankcase 603. Shaft 645 defines a flanged portion 647.

Still referring to FIG. 19, second clutch member 634 includes a shaft 651 including a first shaft portion 650 and a second shaft portion 652. A recessed portion 663 extends radially outwardly from shaft 651. A bearing 648 is positioned between shaft 651 of second clutch member 634 and first clutch member 632. Further, a bearing 678 is positioned between shaft 651 and cover 626. A one-way clutch 667 is positioned between first clutch member 632 and second clutch member 634, that is, one-way clutch 667 is positioned adjacent, or within, recessed member 663 between flanged member 647 of first clutch member 632 and second clutch member 634. Further, one-way clutch 667 is positioned intermediate bearing 648 and bearing 678.

Referring still to FIG. 19, crankcase 603 defines a cavity 619 configured to receive fluid (e.g., oil) from an oil pump. Bearing 608 defines a plurality of apertures 609, and fluid is configured to flow from cavity 619 through apertures 609. Apertures 609 may provide access to one or more conduits to the crankshaft, connecting rods, or other engine components. Crankcase 603 defines an aperture 683 positioned adjacent clutch 630. Crankcase 603 also defines a conduit 680 extending from cavity 619. In embodiments, conduit 680 extends radially outwardly from cavity 619. Crankcase 603 also defines a conduit 682 extending between conduit 680 and aperture 683. That is, cavity 619 is fluidly coupled to aperture 683 through conduit 680 and conduit 682.

Still referring to FIG. 19, a cavity 684 is defined between crankcase 603, crankshaft 620 and first clutch member 632. In embodiments, a seal 685 is coupled between crankcase 603 and flange 638 to prevent fluid (e.g., oil) from flowing out of cavity 684 in undesirable directions. An aperture 687 is defined between flange 638 of first clutch member 632 and flanged portion 624 of crankshaft 620. A conduit 686 is defined between flanged portion 624 and flange 638 of first clutch member 632, and conduit 686 is fluidly coupled to aperture 687. A conduit 688 is defined between a lateral face 625 of crankshaft 620 and inner ring 642 of first clutch member 632, and conduit 688 is fluidly coupled to conduit 686. A conduit 690 is defined between shaft 651 of second clutch member 634 and shaft 645 of first clutch member 632, and bearing 648 is positioned generally within conduit 690 and conduit 690 is fluidly coupled with conduit 688. A conduit 692 is defined between flanged portion 647 of first clutch member 632 and recessed portion 663 and conduit 692 is fluidly coupled to conduit 690. In embodiments, conduit 690 extends generally longitudinally and generally parallel to shaft 651, and conduit 692 extends radially outwardly from conduit 690, and conduit 692 is fluidly coupled to one-way clutch 667. Further, cover 626 defines a conduit 694, and conduit 694 extends between conduit 692 and bearing 678.

Referring still to FIG. 19, fluid (e.g., oil) may flow from a pump (not shown, e.g., fluid pump 24) to cavity 19, and through apertures 609 in bearing 608. Fluid may also flow from cavity 19, through conduit 680, through conduit 682, and out of aperture 683. Fluid flows out of aperture 683, across cavity 684, and into aperture 687. Fluid flows through aperture 687, through conduit 686, through bearing 648 and into conduit 688. Fluid flows through and around bearing 648 to lubricate and cool bearing 648. Fluid may flow from conduit 688 into conduit 690, and through conduit 690 into conduit 692, and fluid may be directed from conduit 692 to bearing 678 to lubricate and cool bearing 678. Fluid may also flow through conduit 690 and may be directed to one-way clutch 667 to lubricate and cool one-way clutch 667. Fluid may then flow through one-way clutch 667 and be directed toward first clutch member 632 to lubricate and cool clutch 630 and components of clutch 630 (e.g., shoes, springs, plates, etc.). In embodiments, fluid (e.g., oil) is configured to flow around crankshaft 620 and shaft 651 to reach clutch member 630.

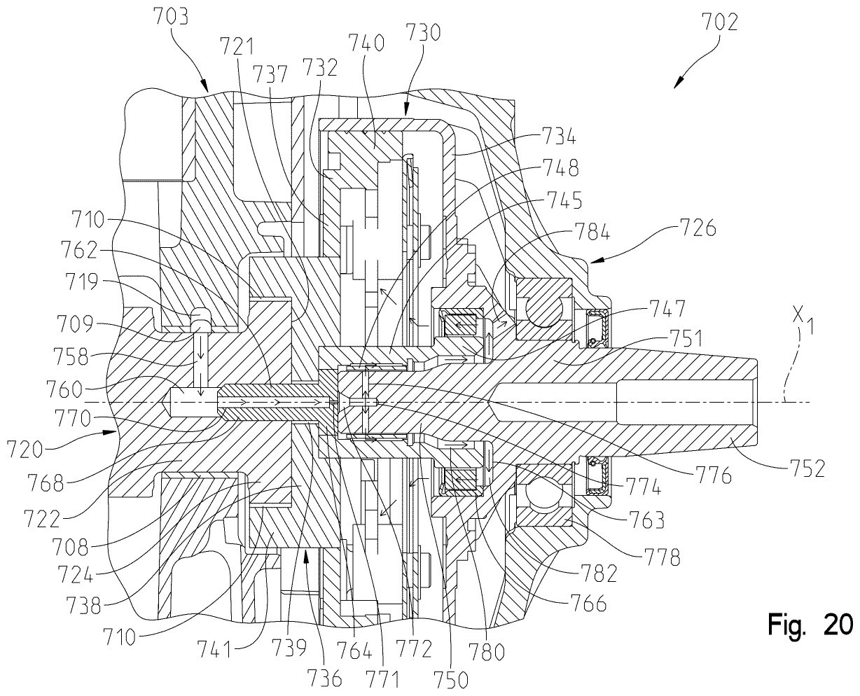

Referring now to FIG. 20, an engine 702, or powertrain 702 may be substantially similar to engine 2. Engine 702 includes a crankcase 703, a crankshaft 720 supported by the crankcase 703, and a cover 726 coupled to the crankcase 703. Crankshaft 720 defines a collared portion 722 and a flanged portion 724 extending outwardly from collared portion 722. A bearing 708 is coupled between crankcase 703 and crankshaft 720 and bearing 708 supports crankshaft 720. In embodiments, bearing 708 defines a plurality of radially extending apertures 709. A clutch 730 is operably coupled between the crankshaft 720 and a transmission (not shown, e.g., transmission 150 (FIG. 11)). Clutch 730 includes an input member 732, or first clutch member 732, and an output member 734, or second clutch member 734. First clutch member 732 includes a plate member 737, a hub member 736 and a shaft member 745. A plurality of shoes 740 are coupled to plate member 737 and move radially outwardly to engage second clutch member 734. Hub member 736 defines a base portion 738 defining an aperture 739, and an extension 741 extending outwardly toward crankcase 703. In embodiments, extension 741 is a cylindrical extension 741 and extends over flanged portion 724. In embodiments, extension 741 is coupled to flanged portion 724 at interface 710, and interface 710 defines a splined interface. That is, extension 741 includes a first portion of a splined interface with a plurality of grooves (not shown), and flanged portion 724 includes a second portion of a splined interface with a plurality of corresponding grooves. That is, extension 741 of first clutch member 732 is rotatably coupled to flanged portion 724 of crankshaft 720 by one or more splines (not shown). In embodiments, shaft member 745 defines a flanged member 747.

In embodiments, first clutch member 732 is a unitary member. That is, in embodiments, hub member 736, plate member 737, and shaft member 745 are combined to be a unitary member. In embodiments, one or more of hub member 736, plate member 737, and shaft member 745 are separate members and may be coupled by an adhesive, fastener, welds, or other methods of coupling.

Still referring to FIG. 20, a bearing 748 is coupled between first clutch member 732 and second clutch member 734. In embodiments, bearing 748 is coupled between first shaft portion 750 and shaft 745. Further, a bearing 778 is coupled between second clutch member 734 and cover 726. In embodiments, bearing 778 is coupled between shaft 751 and cover 726. In embodiments, a one-way clutch member 766 is coupled between first clutch member 732 and second clutch member 734. That is, one-way clutch member 766 is coupled generally within recessed portion 763 between flanged portion 747 and second clutch member 734.

Still referring to FIG. 20, crankshaft 720 defines a conduit 758 extending radially from apertures 709 toward crankshaft rotational axis X1. Crankshaft 720 also defines a conduit 760 extending generally longitudinally along crankshaft rotational axis X1. Conduit 760 is positioned generally within a lateral face 721 of crankshaft 720 and extends between conduit 758 and lateral face 721. A fastener 762 defines a head 764 and a body 768 extending outwardly from head 764. Fastener 762 is configured to extend through both aperture 739 of hub 736 of first clutch member 732. In embodiments, conduit 760 is a threaded conduit 760 and body 768 of fastener 762 is a threaded body (e.g., a screw). That is, fastener 762 is configured to clamp first clutch member 732 to crankshaft 720, and fastener 762 reacts against axial loads imparted on clutch 730 and crankshaft 720. Further, splined joints at interface 710 react against torsional loads transferred between crankshaft 720 and clutch 730. That is, one joint, or interface, is configured to transfer rotational, or torsional loads, while a second joint, or interface, is configured to transfer axial loads between crankshaft 720 and clutch 730. In embodiments, fastener 762 defines a conduit 770 fluidly coupled to conduit 758. Further, head 764 of fastener 762 defines an aperture 771 fluidly coupled to conduit 770. In embodiments, aperture 771 is a metered opening (e.g., a nozzle) which may be configured to build pressure within conduit 770 to increase an exit velocity of fluid (e.g., oil) out of aperture 771.

Still referring to FIG. 20, crankcase 703 defines a conduit 719 surrounding at least a portion of bearing 708 and fluidly coupled with a fluid pump (not shown, e.g., oil pump 24) and a plurality of conduits (not shown, e.g., conduits 18).

Referring still to FIG. 20, second clutch member 734 defines a shaft member 751, including a first shaft portion 750 positioned adjacent crankshaft 720 and a second shaft portion 752 positioned opposite first shaft portion 750. In embodiments, second shaft portion 752 is configured to couple to a transmission (not shown, e.g., transmission 150). Second clutch member 734 also defines a recessed portion 763 extending radially outwardly from shaft 751. In embodiments, first shaft portion 750 defines an aperture 772 positioned opposite of, and adjacent to, aperture 770. First shaft portion 750 also defines a conduit 774 extending longitudinally along crankshaft rotational axis X1 and fluidly coupled to aperture 772. In embodiments, first shaft portion 750 also defines a pair of conduits 776 extending radially outwardly from conduit 774 toward bearing 748. In embodiments, a conduit 780 is defined between shaft 751 of second clutch member 734 and shaft 745 of first clutch member 732. Further, a conduit 782 is defined between the flanged portion 747 of first clutch member 732 and the recessed portion 763 of second clutch member 734. A conduit 784 extends outwardly from conduit 782 toward bearing 778.

Still referring to FIG. 20, fluid (e.g., oil) is configured to flow from a pump (not shown, e.g., oil pump 24) into cavity 719. Fluid may then flow from cavity 719, through apertures 709 of bearing 708 into conduit 758, and through conduit 770 of fastener 762. Fluid may flow from conduit 758 of fastener 762, through aperture 771, and through aperture 772 into conduit 774. Fluid may then flow from conduit 774, and into conduits 776 and the fluid flows radially outwardly toward bearing 748. Fluid flows across bearing 748, lubricating and cooling bearing 748, and flows through conduit 780. Fluid then flows through conduit 780 and radially outwardly into conduit 782. Fluid may then flow from conduit 782 into conduit 784 toward bearing 778. In embodiments, fluid (e.g., oil) flows through conduit 784 and is directed toward bearing 778 to lubricate and cool bearing 778. Further, fluid (e.g., oil) flows through conduit 784 and is directed toward one-way clutch member 766 to lubricate and cool one-way clutch member 766. Fluid (e.g., oil) may then flow through one-way clutch member 776 and is directed toward first clutch member 732 of clutch 730. In embodiments, fluid (e.g., oil) may flow across one or more components of clutch 730 (e.g., springs, shoes, plates, etc.).

Referring now to each of powertrains 2, 202, 302, 402, 502, 602, 702, fluid (e.g., oil) is configured to flow through crankcase (e.g., crankcase 3) and into the cover (e.g., cover 26) and back into oil pan (e.g., oil pan 12). Fluid (e.g., oil) may flow through cover 26 and through and across various components, including bearing 48, one-way clutch member 66, bearing 78, and clutch 30. In this way, fluid (e.g., oil) lubricates and cools each of bearing 48, one-way clutch member 66, bearing 78, and clutch 30. Fluid may then flow out of cover 26 and back into oil pan 12. Crankcase 3 defines an aperture 13 positioned adjacent a bottom of cover 26, and aperture 13 fluidly couples oil pan 12 to cover 26. That is, fluid may flow from various components of clutch 30 (e.g., bearing 48, one-way clutch 66, bearing 78, first clutch member 32) downwardly to a bottom of cover 26, and through aperture 13 and back into oil pan 12. Oil may then flow through oil pan 12, be picked up by oil pump 24, and circulated back through crankcase 3 and cover 26 to lubricate and cool bearing 48, one-way clutch 66, bearing 78, and clutch 30. Each of powertrains 2, 202, 302, 402, 502, 602, 702 may be used alone, or in combination to lubricate and cool bearing 48, one-way clutch 66, bearing 78, and clutch 30.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A driveline assembly, comprising:
an engine including a crankcase;
a crankshaft positioned within the crankcase;
a transmission assembly operably coupled to the crankshaft;
a clutch assembly operably coupled between the crankshaft and the transmission, the clutch assembly having a first side facing the transmission and a second side facing the engine; and
an oil assembly comprising an oil conduit, and the oil conduit configured to direct a fluid toward the first side of the clutch assembly.

2. The driveline assembly of claim 1, wherein the crankshaft defines the oil conduit, and the oil conduit is positioned along a rotational axis of the crankshaft.

3. The driveline assembly of claim 1, wherein the clutch assembly comprises a first clutch member and a second clutch member, and the second clutch member defines the oil conduit.

4. The driveline assembly of claim 3, wherein the oil conduit is a first oil conduit and the oil assembly further comprises a second oil conduit; and the crankshaft defines the second oil conduit and the second oil conduit is configured to direct the fluid to the first oil conduit.

5. The driveline assembly of claim 4, further comprising a one-way clutch coupled between the first clutch member and the second clutch member, and the first oil conduit is configured to direct the fluid to the one-way clutch member.

6. The driveline assembly of claim 5, further comprising a bearing member operably coupled to the second clutch member, and the bearing member is positioned longitudinally intermediate the one-way clutch and the transmission assembly.

7. The driveline assembly of claim 3, wherein the oil conduit comprises a first oil conduit portion and a second oil conduit portion fluidly coupled to the first oil conduit portion, the first oil conduit portion extending generally parallel to the crankshaft and the second oil conduit portion extending radially outwardly from the first oil conduit portion.

8. The driveline assembly of claim 1, wherein the oil conduit extends outwardly from the crankcase.

9. The driveline assembly of claim 8, wherein the clutch assembly comprises a first clutch member and a second clutch member, and the oil conduit extends across a first plane extending vertically through the first clutch member.

10. The driveline assembly of claim 9, wherein the oil conduit is a first oil conduit, and the second clutch member defines a second oil conduit, and the first oil conduit is fluidly coupled to the second oil conduit.

11. The driveline assembly of claim 10, wherein the second oil conduit is configured to direct the fluid to the first clutch member.

12. The driveline assembly of claim 11, further comprising a one-way clutch positioned intermediate the first clutch member and the second clutch member, and the fluid is configured to pass through the one-way clutch.

13. The driveline assembly of claim 1, wherein the clutch assembly comprises a first clutch member rotatably coupled to the crankshaft and a second clutch member rotatably coupled to the transmission, and the second clutch member defines a second clutch member internal conduit, and the oil conduit is configured to direct fluid toward the second clutch member internal conduit.

14. A driveline assembly, comprising:
an engine including a crankcase;
a crankshaft positioned within the crankcase, the crankshaft comprising a first metered opening and a second metered opening;
a transmission assembly operably coupled to the crankshaft; and
an oil assembly fluidly coupled to the first metered opening and the second metered opening.

15. The driveline assembly of claim 14, wherein the first metered opening is positioned along a rotational axis of the crankshaft.

16. The driveline assembly of claim 15, wherein the second metered opening is radially offset from the first metered opening.

17. The driveline assembly of claim 16, wherein the second metered opening is angled relative to the first metered opening.

18. The driveline assembly of claim 14, wherein the first metered opening is fluidly coupled to the second metered opening.

19. The driveline assembly of claim 14, wherein the crankshaft comprises a first end portion and a second end portion opposite the first end portion, and the first end portion comprises a flange extending outwardly from the first end portion, and the flange is positioned intermediate the first metered opening and the second metered opening.

20. The driveline assembly of claim 14, further comprising:
a clutch assembly coupled between the crankshaft and the transmission, the clutch assembly comprising a first clutch member and a second clutch member;
a bearing coupled between the first clutch member and the second clutch member; and a one-way clutch coupled between the first clutch member and the second clutch member;
wherein the first metered opening is configured to provide a fluid to at least two of the first clutch member, bearing, and one-way clutch, and the second metered opening is configured to provide the fluid to at least one of the first clutch member, bearing, and one-way clutch.

21. The driveline assembly of claim 20, wherein the bearing is a first bearing, and a second bearing is coupled to the clutch assembly, and the first metered opening is configured to provide the fluid to each of the first clutch member, first bearing, second bearing, and one-way clutch.

22. The driveline assembly of claim 20, wherein the second metered opening is configured to provide the fluid to only the first clutch member.

23. The driveline assembly of claim 20, wherein the second metered opening is angled relative to the first metered opening.

24. The driveline assembly of claim 20, wherein the second metered opening creates a larger volumetric flow than the first metered opening.

25. The driveline assembly of claim 14, wherein the first metered opening and the second metered opening are differently sized.

26. The driveline assembly of claim 14, wherein the first metered opening and the second metered opening are similarly sized.

27. The driveline assembly of claim 14, further comprising a bearing surrounding the crankshaft, and the bearing defines a channel.

28. The driveline assembly of claim 27, wherein the first metered opening and the second metered opening are fluidly coupled to the channel.

29. The driveline assembly of claim 28, wherein the crankshaft defines a conduit, and the conduit is fluidly coupled to the channel.

30. The driveline assembly of claim 27, wherein the crankshaft defines a flanged end, and the bearing is coupled between the flanged end and the crankcase.

31. The driveline assembly of claim 30, wherein the crankcase defines a cavity, and the cavity surround at least a portion of the bearing.

32. The driveline assembly of claim 31, wherein the bearing defines an aperture fluidly coupling the channel and the cavity.

33. A driveline assembly, comprising:
an engine including a crankcase, the crankcase comprising an outlet;
a crankshaft positioned within the crankcase, the crankshaft defining an internal conduit;
a transmission assembly operably coupled to the crankshaft;
a clutch assembly operably coupled between the crankshaft and the transmission, the clutch assembly having a clutch assembly first side facing the transmission and a clutch assembly second side facing the engine; and
an oil assembly fluidly coupled to the outlet and the internal conduit, the outlet configured to direct fluid to a first one of the clutch assembly first side and clutch assembly second side, and the internal conduit configured to direct fluid to a second one of the clutch assembly first side and the clutch assembly second side.

34. The driveline assembly of claim 33, further comprising a bearing operably coupled to the clutch assembly and a one-way clutch operably coupled to the clutch assembly, and the one of the outlet and the internal conduit configured to direct fluid to the clutch assembly first side is also configured to direct fluid to each of the bearing and the one-way clutch.

35. The driveline assembly of claim 33, further comprising a nozzle positioned within the outlet.

36. The driveline assembly of claim 33, wherein the clutch assembly comprises a first clutch member and a second clutch member, and the first clutch member is rotatably coupled to the crankshaft and the second clutch member is rotatably coupled to the transmission.

37. The driveline assembly of claim 36, wherein the first clutch member comprises a shoe assembly, and the oil assembly is configured to direct fluid to the shoe assembly.

38. The driveline assembly of claim 36, wherein the first clutch member comprises a hub extending generally parallel to the crankshaft.

39. The driveline assembly of claim 38, wherein the second clutch member extends within the hub.

40. The driveline assembly of claim 39, wherein the hub comprises an aperture extending generally perpendicular to a clutch assembly rotation axis.

41. The driveline assembly of claim 33, further comprising a first bearing, a second bearing, and a one-way clutch, and the one-way clutch is positioned intermediate the first bearing and the second bearing.

42. The driveline assembly of claim 41, wherein the one of the outlet and the internal conduit configured to direct fluid to the clutch assembly first side is configured to direct fluid to each of the first bearing, second bearing, and one-way clutch.

43. The driveline assembly of claim 41, wherein the clutch assembly comprises a first clutch member rotatably coupled to the crankshaft and a second clutch member rotatably coupled to the transmission, and the second clutch member has a first side facing the transmission and a second side facing the engine, the second bearing is coupled to the second clutch member on the first side facing the transmission, and the second clutch member includes a second clutch member conduit extending between the first side facing the transmission and the second side facing the engine.

44. The driveline assembly of claim 43, wherein the second clutch member conduit is directed at the second bearing.

45. The driveline assembly of claim 43, wherein the first bearing has a radially extending aperture.

46. The driveline assembly of claim 43, wherein the second clutch member defines a second clutch member internal conduit, and the internal conduit of the crankcase is configured to direct the fluid to the second clutch member internal conduit.
